(19) United States
(12) Patent Application Publication
(10) Pub. No.: US 2021/0195853 A1
(43) Pub. Date: Jul. 1, 2021

(54) MUSHROOM HARVESTING CONTAINER FUNNEL TRAY AND SORTING DEVICE

(71) Applicant: Monterey Mushrooms, Inc., Watsonville, CA (US)

(72) Inventors: Owen R. Barnes, Lenoir City, TN (US); Charles S. Owens, Knoxville, TN (US); Kyle Burriesci, Lenoir City, TN (US)

(21) Appl. No.: 17/132,923

(22) Filed: Dec. 23, 2020

Related U.S. Application Data
(60) Provisional application No. 63/107,272, filed on Oct. 29, 2020.
(60) Provisional application No. 62/956,027, filed on Dec. 31, 2019.

(51) Int. Cl. A01G 18/70; B65D 1/36; B65D 21/02; A23N 15/04; B25J 15/00; B25J 15/06; B25J 9/16; B07C 5/342; B07C 5/10; B07C 5/36

(52) U.S. Cl. CPC A01G 18/70; B65D 1/36; B65D 21/0212; A23N 15/045; B25J 15/0061; B07C 2501/0081; B25J 9/1697; B07C 5/3422; B07C 5/10; B07C 5/362; B25J 15/06

(57) ABSTRACT

The present disclosure relates generally to a container tray for harvesting a plurality of commercially cultivated button-type mushrooms. The present disclosure discusses a mushroom harvesting container tray that cannot only be used for temporarily storing the harvested (picked) mushrooms during the harvesting (picking) process, but the tray can also effectively store and retain the untrimmed mushrooms in place during trimming such that the mushroom stems may be trimmed while being housed in the tray, thereby substantially increasing the efficiency of harvesting mushrooms. For example, the tray holds the mushroom steady while a blade or other cutting mechanism simultaneously trims a plurality of mushroom stems. The present disclosure also relates to a sorting device that determines whether the mushrooms are acceptable and removes the acceptable mushrooms from the tray after the stems have been cut and simultaneously sorts the acceptable mushrooms according to their respective size, shape, color, weight and/or other feature, while also separating or rejecting the unacceptable mushrooms.

### CROSS-REFERENCE TO RELATED APPLICATIONS

The present application claims the benefit of and priority to, under 35 U.S.C. § 119(e), to U.S. Provisional Application Ser. No. 63/107,272, filed Oct. 29, 2020, entitled MUSHROOM HARVESTING CONTAINER FUNNEL TRAY AND SORTING DEVICE and to U.S. Provisional Application Ser. No. 62/956,027, filed Dec. 31, 2019, entitled MUSHROOM HARVESTING CONTAINER FUNNEL TRAY. The above applications are hereby incorporated by reference in their entireties for all that they teaches and for all purposes.

### TECHNICAL FIELD

The present disclosure relates generally to a container tray for harvesting a plurality of commercially cultivated button-type mushrooms. More specifically, the present disclosure relates to a container tray for harvesting a plurality of commercially cultivated button-type mushrooms such that the tray can be used to store such mushrooms having a variety of sizes and efficiently trim the stems of the mushrooms while they are stored in the tray. The present disclosure also relates generally to a sorting device to remove the mushrooms from the container tray.

### BACKGROUND

Harvesting mushrooms, such as commercially cultivated button-type mushrooms, is typically a manual-intensive process. After a mushroom harvester visually identifies and selects which mushrooms are ready for picking, the harvester typically removes the identified mushrooms from a growing substrate, evaluates and gauges the size of each mushroom, and then trims the stem of each mushroom to a length that is proportional to the diameter of the mushroom cap. This process is performed on an individual basis. That is, each of the aforementioned steps is performed on a serial basis for each mushroom—one at a time. At best, a harvester may pick a couple or few (e.g., 2, 3 or 4) mushrooms with one hand, and while holding those couple or few mushrooms in that hand, use the other hand to individually trim each of those mushrooms.

During this process, the remnant portion of the mushroom stems (stumps) accumulate in a designated container. When the container of stems becomes full, the harvester must stop picking mushrooms to empty the container, thereby further decreasing efficiency. As such, the combined tasks of selecting, picking, trimming, and handling of mushrooms and containers requires the development of significant skill over time in order to become economically efficient for both the harvester and the harvester's employer.

### SUMMARY

What is needed is a process of harvesting mushrooms that is less manually intensive and more efficient. The present disclosure discusses a mushroom harvesting container tray that not only temporarily stores the harvested (picked) mushrooms during the harvesting (picking) process, but the tray can also effectively store and retain the untrimmed mushrooms in place during trimming such that the mushroom stems may be trimmed while being housed in the tray, thereby substantially increasing the efficiency of harvesting mushrooms. For example, the tray holds the mushroom steady while a blade or other cutting mechanism simultaneously trims a plurality of mushroom stems.

For example, a container tray may comprise: a top side; a bottom side; and a plurality of funnel-shaped receptacles, wherein each of the plurality of funnel-shaped receptacles comprises a top opening on the top side, a bottom opening on the bottoms side, and a wall extending from the top opening to the bottom opening, wherein the top opening has a size and the bottom opening has a size, wherein the size of the top opening is greater than the size of the bottom opening and wherein the wall is extends radially inward as the wall extends vertically from the top opening to the bottom opening.

Another example includes the container tray of the previous paragraph, wherein the plurality of funnel-shaped receptacles are arranged in a plurality of rows and a plurality of columns.

Another example includes the container tray of any of the previous paragraphs, wherein the plurality of funnel-shaped receptacles comprise a centrally located funnel-shaped receptacle relative to four funnel-shaped receptacles.

Another example includes the container tray of any of the previous paragraphs, wherein the four funnel-shaped receptacles are spaced evenly around a circumference for the centrally located funnel-shaped receptacle.

Another example includes the container tray of any of the previous paragraphs, wherein the four funnel-shaped receptacles are spaced 90 degrees around the circumference for the centrally located funnel-shaped receptacle.

Another example includes the container tray of any of the previous paragraphs, wherein the centrally located funnel-shaped receptacle comprises a rim, and the four surrounding funnel-shaped receptacles share a portion of the rim of the centrally located funnel-shaped receptacle.

Another example includes the container tray of any of the previous paragraphs, wherein the plurality of funnel-shaped receptacles comprise a centrally located funnel-shaped receptacle relative to five funnel-shaped receptacles.

Another example includes the container tray of any of the previous paragraphs, wherein the five funnel-shaped receptacles are spaced evenly around a circumference for the centrally located funnel-shaped receptacle.

Another example includes the container tray of any of the previous paragraphs, wherein the five funnel-shaped receptacles are spaced 72 degrees around the circumference for the centrally located funnel-shaped receptacle.

Another example includes the container tray of any of the previous paragraphs, wherein the centrally located funnel-shaped receptacle comprises a rim, and the five surrounding funnel-shaped receptacles share a portion of the rim of the centrally located funnel-shaped receptacle.

Another example includes the container tray of any of the previous paragraphs, wherein the plurality of funnel-shaped receptacles comprise a centrally located funnel-shaped receptacle relative to six funnel-shaped receptacles.

Another example includes the container tray of any of the previous paragraphs, wherein the six funnel-shaped receptacles are spaced evenly around a circumference for the centrally located funnel-shaped receptacle.

Another example includes the container tray of any of the previous paragraphs, wherein the six funnel-shaped receptacles are spaced 60 degrees around the circumference for the centrally located funnel-shaped receptacle.

Another example includes the container tray of any of the previous paragraphs, wherein the centrally located funnel-shaped receptacle comprises a rim, and the six surrounding funnel-shaped receptacles share a portion of the rim of the centrally located funnel-shaped receptacle.

Another example includes the container tray of any of the previous paragraphs further comprising a plurality of gussets, wherein each of the plurality of gussets is coupled to two funnel-shaped receptacles.

Another example includes the container tray of any of the previous paragraphs, wherein at least one of the plurality of gussets is triangularly shaped as the at least one of the plurality of gussets extends from the top side to the bottom side.

Another example includes the container tray of any of the previous paragraphs, wherein at least two of the plurality of gussets cross.

Another example includes the container tray of any of the previous paragraphs, wherein the at least one of the plurality of gussets are triangularly shaped as the at least two of the plurality of gussets extend from the top side to the bottom side.

Another example includes the container tray of any of the previous paragraphs, wherein the container tray further comprises a means for stacking the container tray to or with another container tray.

Another example includes the container tray of any of the previous paragraphs, wherein the means for stacking the container tray to or with another container tray comprise a plurality of protrusions extending from the top side.

What is also needed is a device for automatically sorting and removing (or transporting) the mushrooms from the container tray and automatically separating the mushrooms from one another. The present disclosure also discusses a sorting device that performs these automated functions. For example, a device for individually transporting a plurality of mushrooms from a container tray may comprise the following: a frame; a plurality of movable suction cups coupled to and extending from the frame; a pressure source fluidly coupled to the plurality of the movable suction cups; a computing system comprising: one or more processors; and memory storing instructions that, when executed by the one or more processors, cause the one or more processors to: receive a plurality of image signals corresponding to a plurality of images of a plurality of mushrooms within a tray; co-register the plurality of image signals and a plurality of positions corresponding to the plurality of mushrooms within the tray; determine a size, shape, color, weight and/or other feature of each of the plurality of mushrooms based on the corresponding image for each of the plurality of mushrooms; assign a category to each of the plurality of mushrooms based on the size, shape, color, weight and/or other feature of each of the plurality of mushrooms; determine whether each of the plurality of mushrooms is acceptable based on the category assigned to each of the plurality of mushrooms; and engage the movable suction cups corresponding to each of the plurality of mushrooms determined to be acceptable.

Another example includes the device of the previous paragraph, wherein co-registering the plurality of image signals and the plurality of positions corresponding to the plurality of mushrooms comprises co-registering the plurality of movable suction cups with the plurality of positions corresponding to the plurality of mushrooms.

Another example includes the device of any of the previous paragraphs, wherein receiving the plurality of image signals corresponding to the plurality of images of the plurality of mushrooms comprises receiving a first plurality of image signals corresponding to a plurality of images of a plurality of caps of the mushrooms.

Another example includes the device of any of the previous paragraphs, wherein co-registering the plurality of image signals and the plurality of positions corresponding to the plurality of mushrooms comprises co-registering the plurality of images of the plurality of caps of the mushrooms and the plurality of positions corresponding to the plurality of mushrooms.

Another example includes the device of any of the previous paragraphs, wherein assigning the category to each of the plurality of mushrooms is based on the size, shape, color and/or other feature of each of the plurality of mushroom caps either with or without the weight of each of the plurality of mushrooms.

Another example includes the device of any of the previous paragraphs, wherein receiving the plurality of image signals corresponding to the plurality of images of the plurality of mushrooms comprises receiving a second plurality of image signals corresponding to a plurality of images of a plurality of stems of the mushrooms.

Another example includes the device of any of the previous paragraphs, wherein co-registering the plurality of image signals and the plurality of positions corresponding to the plurality of mushrooms comprises co-registering the plurality of images of the plurality of caps of the mushrooms, the plurality of stems of the mushrooms and the plurality of positions corresponding to the plurality of mushrooms.

Another example includes the device of any of the previous paragraphs, further comprising co-registering the plurality of movable suction cups with the plurality of positions corresponding to the plurality of caps of the mushrooms.

Another example includes the device of any of the previous paragraphs, wherein assigning the category to each of the plurality of mushrooms is based on the size, shape, color and/or other feature of each of the plurality of mushroom caps and stems of the mushrooms either with or without the weight of each of the plurality of mushrooms.

Another example includes the device of any of the previous paragraphs, further comprising engaging the movable suction cups corresponding to each of the plurality of mushrooms determined to be unacceptable.

Another example includes the device of any of the previous paragraphs, further comprising removing each of the plurality of mushrooms determined to be unacceptable from the tray.

Another example includes the device of any of the previous paragraphs, further comprising removing each of the plurality of mushrooms determined to be acceptable from the tray.

Another example includes the device of any of the previous paragraphs, further comprising separating the plurality of mushrooms determined to be unacceptable from the plurality of mushrooms determined to be acceptable.

What is also needed is a device for individually transporting and/or sorting a plurality of mushrooms from a container tray, the device comprising: a frame; at least one prime mover coupled to the frame, wherein the at least one prime mover configured to move the frame; a plurality of suction cups coupled to and extending from the frame; a pressure source fluidly coupled to the plurality of the suction cups; a computing system comprising: one or more processors; and memory storing instructions that, when executed by the one or more processors, cause the one or more processors to: receive a plurality of image signals corresponding to a plurality of top-view images of a plurality of mushrooms within a tray; determine a size, shape, color, weight and/or other feature of each of the plurality of mushrooms based on the corresponding top-view image for each of the plurality of mushrooms; determine the weight of each of the plurality of mushrooms; assign a category to each of the plurality of mushrooms based on the size, shape, color, weight and/or other feature of each of the plurality of mushrooms; determine whether each of the plurality of mushrooms is acceptable based on the category assigned to each of the plurality of mushrooms; engage the suction cups corresponding to each of the plurality of mushrooms determined to be acceptable, wherein the suction cups remove the plurality of mushrooms from the tray; receive a plurality of image signals corresponding to a plurality of bottom-view images of a plurality of mushrooms while retained by the movable suction cups; determine whether each of the plurality of mushrooms is acceptable based on the corresponding bottom-view image for each of the plurality of mushrooms; and sort each of the plurality of mushrooms based on (i) the size, shape, color, weight and/or other feature of each of the plurality of mushrooms and (ii) a determination from the bottom-view image that the each of the plurality of mushrooms is acceptable.

Another example includes the device of the previous paragraph, wherein each of the plurality of mushrooms determined to be unacceptable remains in the tray.

Another example includes the device of any of the previous paragraphs, wherein the memory storing instructions that, when executed by the one or more processors, cause the one or more processors to move the tray containing the plurality of mushrooms determined to be unacceptable.

Another example includes the device of any of the previous paragraphs, wherein the category assigned to each of the plurality of mushrooms is based on the size of each of a top portion of the plurality of mushrooms.

Another example includes the device of any of the previous paragraphs, wherein the category assigned to each of the plurality of mushrooms is based on the color of each of a top portion of the plurality of mushrooms.

Another example includes the device of any of the previous paragraphs, wherein the category assigned to each of the plurality of mushrooms is based on the weight of each of the plurality of mushrooms.

Another example includes the device of any of the previous paragraphs, wherein the category assigned to each of the plurality of mushrooms is based on the size and the color of each of a top portion of the plurality of mushrooms.

Another example includes the device of any of the previous paragraphs, wherein the category assigned to each of the plurality of mushrooms is based on the size and the color of each of a top portion of the plurality of mushrooms and the weight of each of the plurality of mushrooms.

Another example includes the device of any of the previous paragraphs, wherein the category assigned to each of the plurality of mushrooms is based on the size, the shape and the color of each of a top portion of the plurality of mushrooms.

Another example includes the device of any of the previous paragraphs, wherein the category assigned to each of the plurality of mushrooms is based on the size, the shape and the color of each of a top portion of the plurality of mushrooms and the weight of each of the plurality of mushrooms.

Another example includes the device of any of the previous paragraphs, wherein the determination from the bottom-view image of whether each of the plurality of mushrooms is acceptable is based on a color of a bottom portion of each of the plurality of mushrooms.

Another example includes the device of any of the previous paragraphs, wherein the determination from the bottom-view image of whether each of the plurality of mushrooms is acceptable is based on a color of a bottom portion of each of the plurality of mushrooms and the weight of each of the plurality of mushrooms.

While multiple embodiments are disclosed, still other embodiments of the present disclosure will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

FIG. 1 is a perspective view of the top side of an empty container tray, in accordance with the present disclosure.

FIG. 2 is a perspective view of the bottom side of the empty container tray, in accordance with the present disclosure.

FIG. 3 is an enlarged perspective view of a portion of the top side of the container tray depicted in FIG. 1, in accordance with the present disclosure.

FIG. 4 is an enlarged perspective view of a portion of the bottom side of the container tray depicted in FIG. 2, in accordance with the present disclosure.

FIGS. 5 and 6 are end views of the container tray depicted in FIGS. 1-4, in accordance with the present disclosure.

FIGS. 7 and 8 are side views of the container tray depicted in FIGS. 1-6, in accordance with the present disclosure.

FIG. 9 is a top view of the container tray depicted in FIG. 1, in accordance with the present disclosure.

FIG. 10 is a bottom view of the container tray depicted in FIG. 2, in accordance with the present disclosure.

FIG. 11 is a perspective view of the top side of the container tray depicted in FIG. 1 with mushrooms stored therein, in accordance with the present disclosure.

FIG. 12 is a perspective view of the bottom side of the container tray depicted in FIG. 2 with mushrooms stored therein prior to cutting the stems of the mushrooms, in accordance with the present disclosure.

FIG. 13A is a cross-sectional view of the container tray depicted in with mushrooms stored therein prior to cutting the stems of the mushrooms, in accordance with the present disclosure.

FIG. 13B is a cross-sectional view of the container tray depicted in with mushrooms stored therein subsequent to cutting the stems of the mushrooms, in accordance with the present disclosure.

FIG. 14 is a cross-sectional view of the empty container tray, in accordance with the present disclosure.

FIG. 14A is a cross-sectional view of one receptacle of the empty container tray, in accordance with the present disclosure.

FIG. 15 is a perspective view of the bottom side of the container tray depicted in FIG. 2 with mushrooms stored therein subsequent to cutting the stems of the mushrooms, in accordance with the present disclosure.

FIG. 16 is a perspective view of the top side of an alternative example of an empty container tray, in accordance with the present disclosure.

FIG. 17A is a perspective view of the bottom side of the alternative example of an empty container tray depicted in FIG. 16, in accordance with the present disclosure.

FIG. 17B is a different perspective view of the bottom side of the alternative example of an empty container tray depicted in FIG. 16, in accordance with the present disclosure.

FIG. 18 is an end view and side view of the container tray depicted in FIGS. 16-17, in accordance with the present disclosure.

FIG. 19 is a top view of the container tray depicted in FIGS. 16-17, in accordance with the present disclosure.

FIG. 20 is a bottom view of the container tray depicted in FIGS. 16-17, in accordance with the present disclosure.

FIG. 21A is a bottom perspective view of a sorting device, in accordance with the present disclosure, with a plurality of sub-assemblies attached thereto.

FIG. 21B is a top perspective view of a sorting device, in accordance with the present disclosure, with all of the sub-assemblies attached thereto.

FIG. 21C is a top perspective view of a sorting device, in accordance with the present disclosure, with one of the sub-assemblies attached thereto.

FIG. 22 is a top perspective view of a portion of a sub-assembly of the sorting device, in accordance with the present disclosure.

FIG. 23 is a bottom perspective view of a portion of a sub-assembly of the sorting device, in accordance with the present disclosure.

FIG. 24 is an exemplary block diagram of a workstation having a control system to operate the sorting device, in accordance with the present disclosure.

FIG. 25 is a flow diagram depicting a method of operating the workstation and sorting device, in accordance with the present disclosure.

FIG. 26 is a flow diagram depicting another method of operating the workstation and sorting device, in accordance with the present disclosure.

Although the term “block” may be used herein to connote different elements illustratively employed, the term should not be interpreted as implying any requirement of, or particular order among or between, various blocks disclosed herein. Similarly, although illustrative methods may be represented by one or more drawings (e.g., flow diagrams, communication flows, etc.), the drawings should not be interpreted as implying any requirement of, or particular order among or between, various steps disclosed herein. However, certain embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

### DETAILED DESCRIPTION

While the disclosed subject matter is amenable to various modifications and alternative forms, specific embodiments have been shown by way of example in the drawings and are described in detail below. The intention, however, is not to limit the disclosed subject matter to the particular embodiments described. On the contrary, the disclosed subject matter is intended to cover all modifications, equivalents, and alternatives falling within the scope of the disclosed subject matter as defined by the appended claims.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

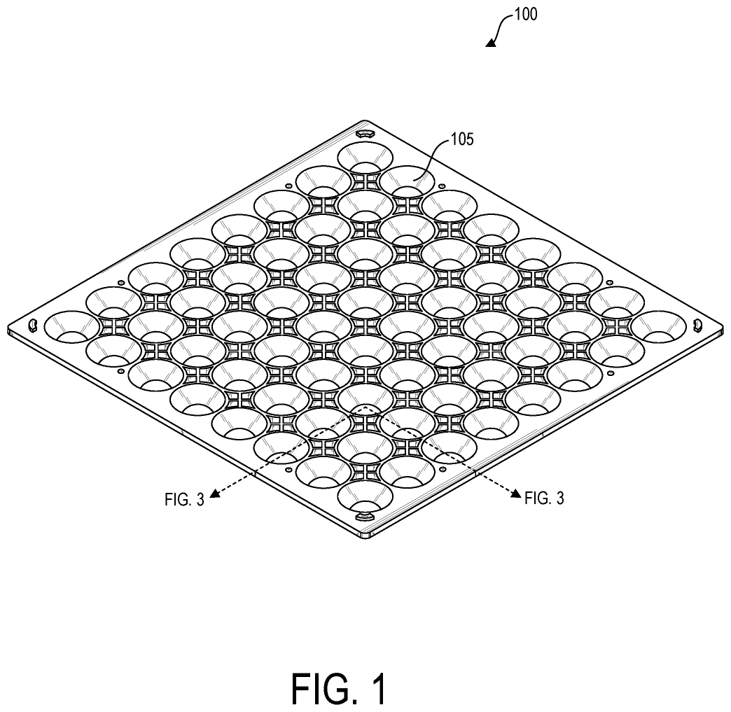

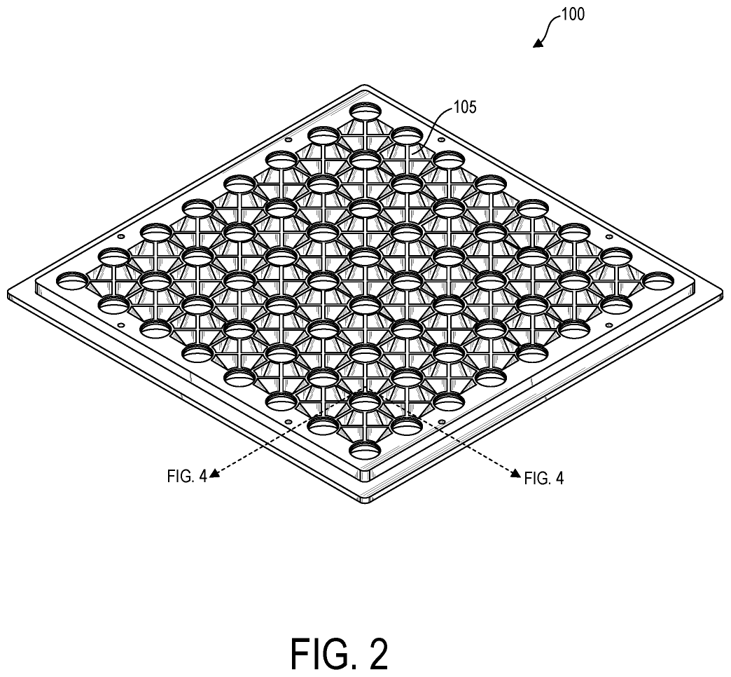

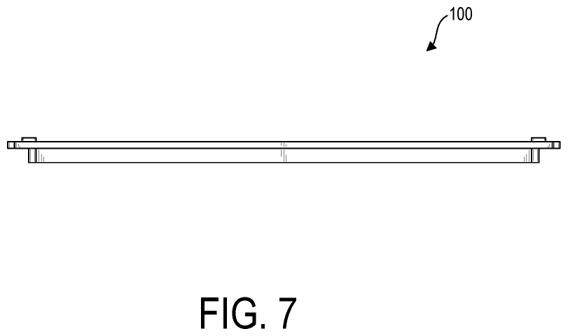

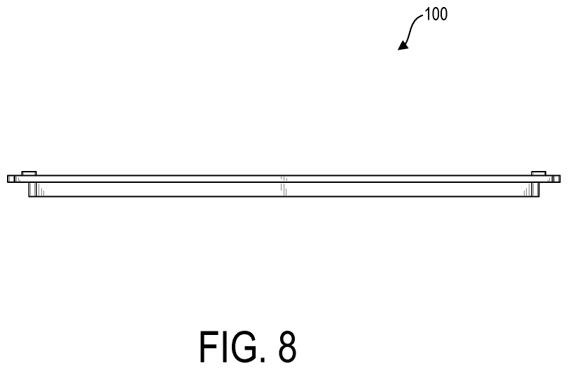

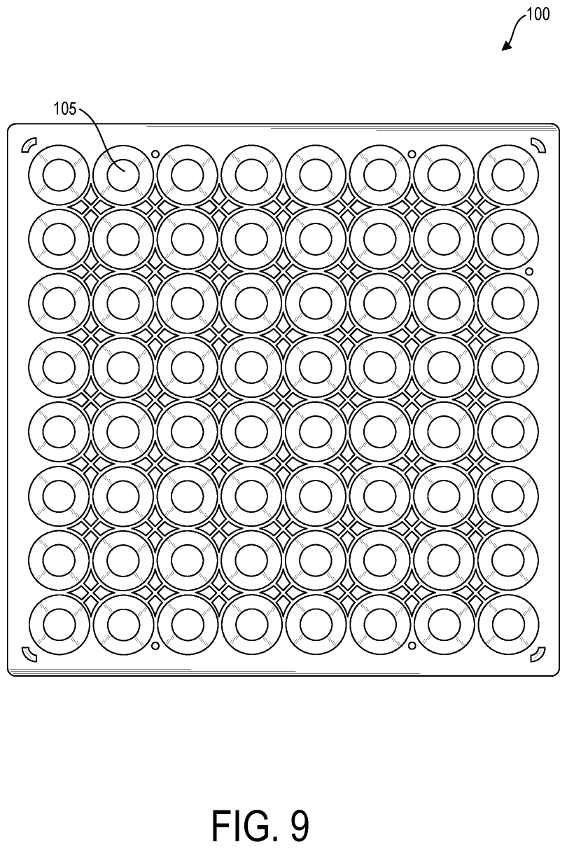

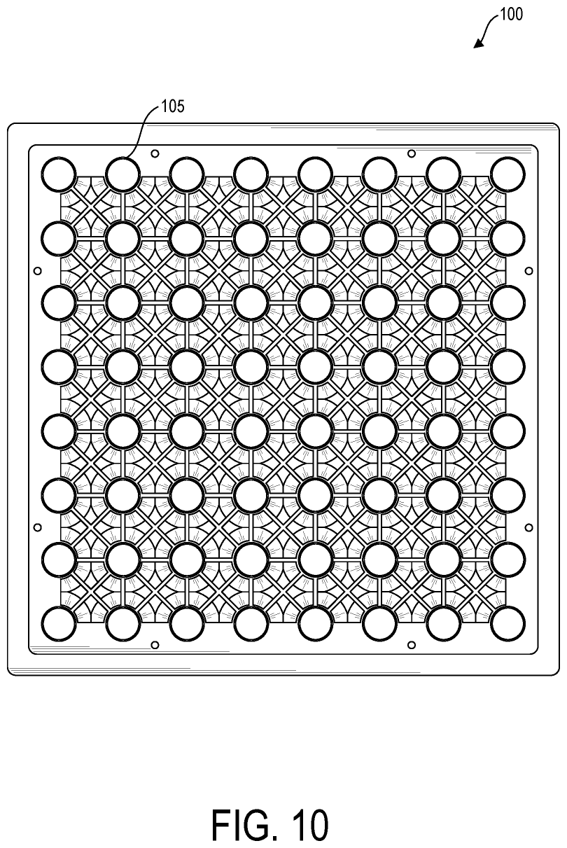

Referring to FIGS. 1-4, 9, 10, 14 and 14A, there is depicted an example of an empty container tray 100, in accordance with the present disclosure. The container tray 100 includes a plurality of funnel-shaped receptacles 105 (or cavities), which are arranged in a series of rows and columns. For example, FIGS. 1-4 and 9-10 illustrate eight (8) rows and eight (8) columns of receptacles 105 in the tray 100, thereby totaling sixty-four (64) receptacles 105 per tray 100. Because each receptacle 105, can retain and store one (1) mushroom, the tray 100 can retain and store a total of sixty-four (64) mushrooms 200. For example, referring to FIGS. 11, 12 and 13A, there are shown a plurality of mushrooms 200 in a corresponding plurality of receptacles 105, wherein each mushroom 200 has a cap portion 205 that extends above the top side 140 of the tray 100, and each mushroom 200 has a stem 210 that extends below the bottom side 145 of the tray 100. Although it is not shown in these figures, the cap portions 205 of smaller mushrooms 200 may not extend above the top side 140 of the tray 100, and if so, the top of the cap portions 205 will be recessed within the receptacles 105.

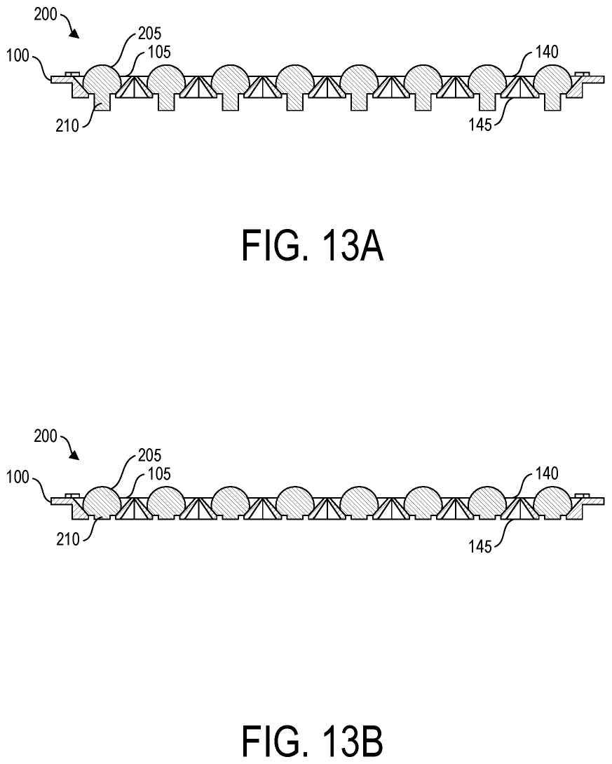

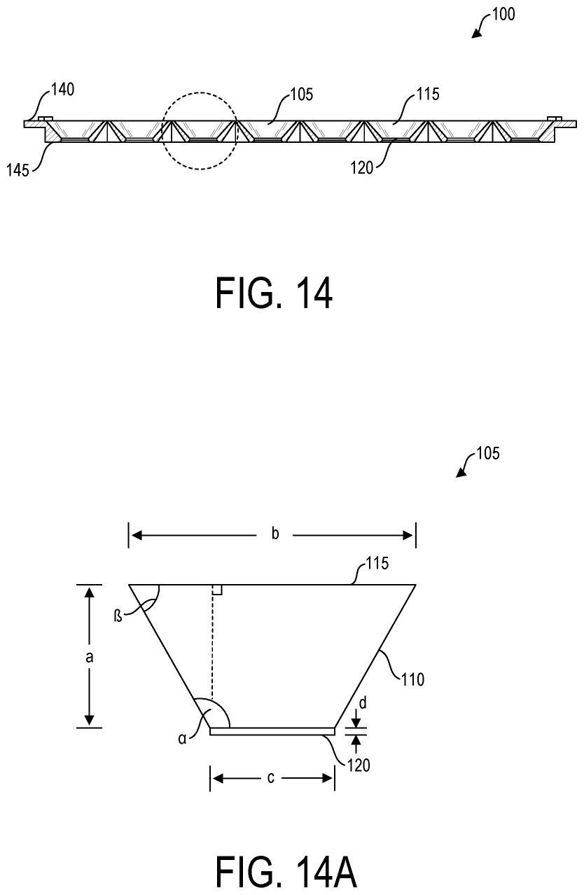

Referring to FIGS. 14 and 14A, there is depicted a cross-sectional view of the empty container tray 100 so as to more easily illustrate and discuss the configuration of each receptacle 105. Each receptacle 105 comprises a top opening 115 on the top side 140 (or top surface) of the tray 100, a bottom opening 120 on the bottom side 145 (or top surface) of tray 100, and an angled wall 110 extending from the top opening 115 (and the top side 140) to the bottom opening 120 (and the bottom side 145). The wall 110 is angled similar to the wall of a funnel or open-shaped cone because the top opening 115 is greater in size than the bottom opening 120. Both the top opening 115 and the bottom opening 120 are circular in shape; hence, the rims of the top opening 115 and the bottom opening 120 have respective circumferences and diameters, wherein the diameter and circumference of the top opening 115 is larger than the diameter and circumference of the bottom opening 120. Although the top opening 115 and the bottom opening 120 are circular, any of the openings may have a different shape, such as oval, triangular, square, rectangular, pentagon, hexagon, octagon, etc. Regardless of the shape of the top opening 115 and the bottom opening 120, it may be preferable for the rims of the openings to be chamfered to increase the ease with which the mushrooms release from the receptacle 105 while the stems 210 extend through the bottom opening 120.

Referring to FIG. 14A, there is shown an enlarged cross-sectional view of one receptacle 105. The receptacle 105 comprises a top opening 115 having a diameter (b) and a bottom opening 120 having a diameter (c), wherein the top opening 115 is greater than the bottom opening 120. The container tray 100 also has a height (a) measured vertically straight from the top side 140 of the container tray 100 to the bottom side 145 of container tray 100. Again, the wall 110 is angled (or tapered inwardly from the top side 140 to the bottom side 145 similar to a funnel) because the top opening 115 is greater in size than the bottom opening 120. The receptacle 105, therefore, comprises an angle (α) measured at the intersection of the bottom opening 120 and the wall 110, as well as an angle (β) measured at the intersection of the top opening 120 and the wall 110. Based on the foregoing, it may be preferable for the dimensions of the receptacle 105 to be as follows:

TABLE 1

| | Height (a) | Diameter (b) | Diameter (c) | Angle (α) | Angle (β) |
|---|---|---|---|---|---|
| | Centimeters | Centimeters | Centimeters | Degrees | Degrees |
| Narrow | 1.27 | 4.445 | 1.905 | 135 | 45 |
| Range | | | | | |
| Medium | 1.905 | 5.3975 | 2.8575 | 130 | 50 |
| Range | | | | | |
| Wide | 3.81 | 11.43 | 5.08 | 140 | 40 |
| Range | | | | | |

As shown in Table 1 above, the height (a) of the receptacle 105 may between about 1.25 centimeters (cm) and 3.85 cm or any increment therebetween including about 1.3 cm, 1.35 cm, 1.4 cm, 1.45 cm, 1.50 cm, 1.55 cm, 1.60 cm, 1.65, 1.70 cm, 1.75 cm, 1.80 cm, 1.85 cm, 1.90 cm, 1.95 cm, 2.00 cm, 2.05 cm, 2.10 cm, 2.15 cm, 2.20 cm, 2.25 cm, 2.30 cm, 2.35 cm, 2.40 cm, 2.45 cm, 2.50 cm, 2.55 cm, 2.60 cm, 2.65 cm, 2.70 cm, 2.75 cm, 2.80 cm, 2.85 cm, 2.90 cm, 3.00 cm, 3.05 cm, 3.10 cm, 3.15 cm, 3.20 cm, 3.25 cm, 3.30 cm, 3.35 cm, 3.40 cm, 3.45 cm, 3.50 cm, 3.55 cm, 3.60 cm, 3.65 cm, 3.70 cm, 3.75 cm, 3.80 cm and 3.85 cm. Because the top opening 115 and the bottom opening 120 are concentric relative to one another and the wall 110 of the receptacle 105 is symmetrical along at least a portion of the height (a) or a majority of the height (a), the wall 110 forms a substantially symmetrically shaped receptacle 105.

As shown in Table 1 above, the diameter (b) of the top opening of the receptacle 105 may between about 4.00 centimeters (cm) and 12.00 cm or any increment therebetween including about 4.25 cm, 4.50 cm, 4.75 cm, 5.0 cm, 5.25 cm, 5.50 cm, 5.75 cm, 6.0 cm, 6.25 cm, 6.50 cm, 6.75 cm, 7.0 cm, 7.25 cm, 7.50 cm, 7.75 cm, 8.00 cm, 8.25 cm, 8.50 cm, 8.75 cm, 9.00 cm, 9.25 cm, 9.50 cm, 9.75 cm, 10.00 cm, 10.25 cm, 10.50 cm, 10.75 cm, 11.00 cm, 11.25 cm, 11.50 cm and 11.75 cm.

As shown in Table 1 above, the diameter (c) of the bottom opening of the receptacle 105 may between about 1.50 centimeters (cm) and 5.50 cm or any increment therebetween including about 1.75 cm, 2.00 cm, 2.25 cm, 2.50 cm, 2.75 cm, 3.00 cm, 3.25 cm, 3.50 cm, 3.75 cm, 4.00 cm, 4.25 cm, 4.50 cm, 4.75 cm, 5.00 cm and 5.25 cm. The angle (α) may be between about 130 and 140 degrees or any increment therebetween including about 130.5, 131.0, 131.5, 132.0, 132.5, 133.0, 133.5, 134.0, 134.5, 135.0, 135.5, 136.0, 136.5, 137.0, 137.5, 138.0, 138.5, 139.0 and 139.5 degrees. The angle (β) may be between about 40 and 50 degrees or any increment therebetween including about 40.5, 41.0, 41.5, 42.0, 42.5, 43.0, 43.5, 44.0, 44.5, 45.0, 45.5, 46.0, 46.5, 47.0, 47.5, 48.0, 48.5, 49.0 and 49.5 degrees. The height of the receptacle 105 may also extend a further distance (d), which can be between about 0.50 mm to about 10.0 mm or any increment therebetween including about 1.0 mm. 1,5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm and 9.5 mm at a constant diameter (c). This additional distance (d), in addition to distance (a), may also assist in maintaining the mushrooms 200 to be held in place within the receptacles 105 as a blade or cutting device (not shown) traverses across the bottom openings 120 and/or the bottom side 145 of the container tray 100 and simultaneously cuts and trims a plurality of mushroom stems 210.

These dimensions for the receptacles 105 allow the stems 210 of the mushrooms 200 to extend below the bottom side 145 of the container tray 100 while allowing at least a portion of the cap portion 205 of the mushrooms 200 to contact the walls 110 of the receptacles 105. The cap portion 205 of the mushroom 200 may also be referred to as the top portion or the button portion of the mushroom 200. Because the cap portion 205 of each of the mushrooms 200 contacts the wall 110 of a corresponding receptacle 105, each mushroom 200 is held in place within the receptacle 105 as a blade or cutting device (not shown) traverses across the bottom openings 120 and/or the bottom side 145 of the container tray 100 relative to the container tray 100.

For example, while the stems 210 extend from the bottom side of the container tray, the blade may remain stationary while the container tray 100 moves. the blade may move while the container tray 100 remains stationary or the blade may move while the container tray 100 moves in the same or opposite direction that the blade moves, thereby simultaneously cutting and trimming a plurality of mushroom stems. Assuming the blade remains stationary while the container tray 100 moves, the blade may be oriented substantially perpendicular (i.e., 90 degrees) relative to the direction that the container tray 100 moves or the blade may be oriented at an acute angle (i.e., an angle greater than 0 degrees and less than 90 degrees) relative to the direction that the container tray 100 moves or the blade may be oriented at an obtuse angle (i.e., an angle greater than 90 degrees and less than 180 degrees) relative to the direction that the container tray 100 moves. Similarly, assuming the container tray 100 moves while the blade remains stationary, the blade may be oriented substantially perpendicular, at an acute angle or at an obtuse angle relative to the container tray 100. The blade may be a straight blade or a rotary blade, such as an auger shaped blade. Assuming the blade moves parallel to the direction in which the container tray 100 travels the blade may be oriented substantially perpendicular, at an acute angle or at an obtuse angle relative to the container tray 100.

Also, regardless of whether the blade remains stationary while the container tray 100 moves or the blade moves while the container tray 100 remains stationary, the blade may vibrate at an sonic or ultrasonic rate. For example, the blade may repeatedly move or vibrate toward and away the mushrooms 200 extending from the container tray 100 at a rate of between 10-80 kHz. Specifically, the blade may remain in a generally fixed position but vibrate in a direction parallel to which the container tray 100 travels over the blade. In other words, the blade may move or vibrates in direction parallel to the direction that the container tray 100 travels. As the container tray 100 moves over the blade, the blade vibrates back and forth in the parallel direction, the mushroom 200 moves relative to the bottom side 145 of, the container tray 100 and the blade simultaneously cuts and trims a plurality of mushroom stems 210 extending from the bottom side of the container tray. In addition or alternatively to the blade and the container tray moving in relatively parallel directions, the blade and the container tray may move in perpendicular to one another. For example, as the container tray 100 moves over the blade, the blade vibrates back and forth in a direction perpendicular to that which the container tray 100 moves, thereby cutting and trimming the mushroom stems 210 extending from the bottom side of the container tray. Vibrating the blade to cut the stems results in extending and increasing the shelf life of the mushrooms, including the mushroom stems.

Another cutting means for trimming the mushroom stems may include one movable sheet or a pair of movable sheets having a plurality of sharp openings (e.g., circular, oval, etc.) therethrough, wherein the movable sheet or a pair of movable sheets are disposed at or below the openings at the bottom of the container tray 100. The single sheet or a pair sheets may have a similar number of openings as the container tray 100. When the mushrooms are inserted into the container tray 100, the stems 210 extend through the openings in the container tray 100 and through the sharp openings in the sheet or pair sheets. Upon activation of the cutting means, the sheet or pair sheets move in one or more directions (e.g., toward one another if there are two sheets) to close the openings and trim and cut the mushroom stems similar to a way in which a pair of circular scissors or trimmers would cut the stems.

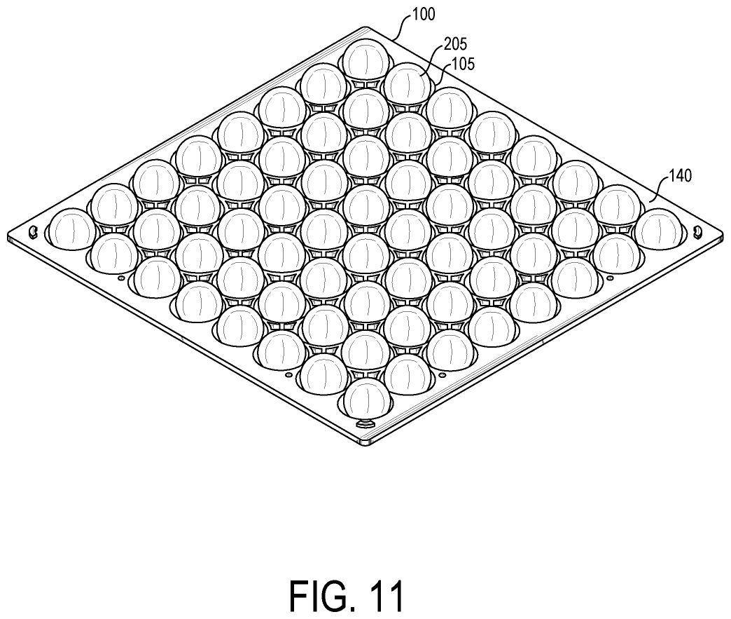

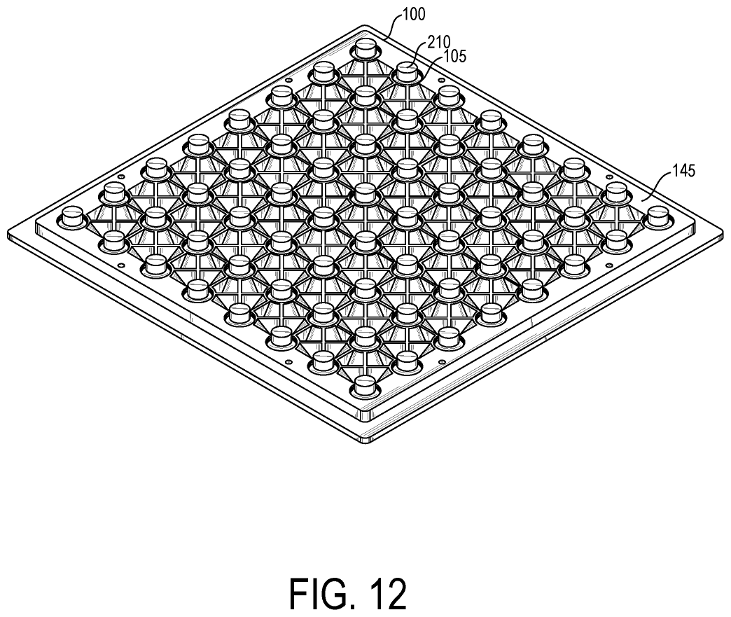

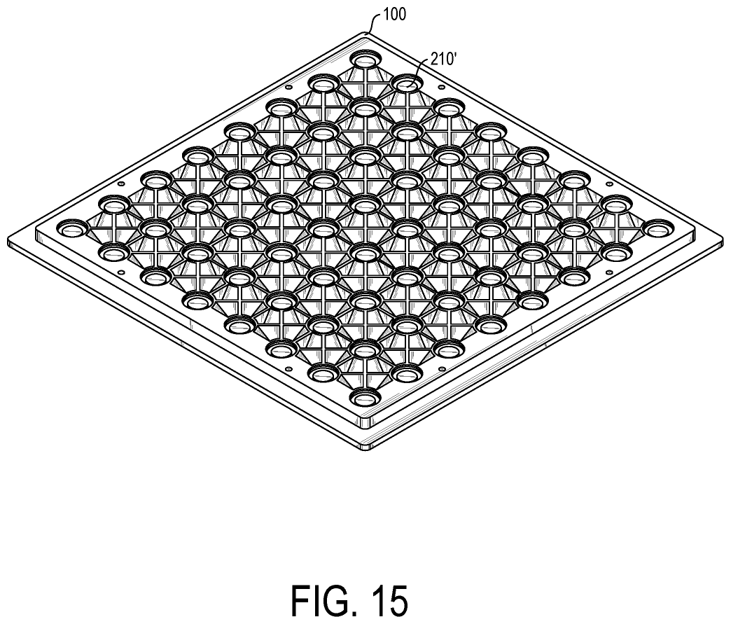

It may also be preferable for the blade or cutting device to traverses across the bottom openings 120 and/or the bottom side 145 of the container tray 100 without contacting the bottom side 145 of the container tray. That is, it may be preferable for the blade or cutting device to traverses across the bottom openings 120 and/or the bottom side 145 of the container tray 100 a fixed or predetermined distance (e.g., 1mm to 20 mm) from the bottom side 145 of the container tray. For example, referring to FIGS. 13B and 15, there is shown the mushrooms 200 within the receptacles 105, wherein the stems 210 of the mushrooms 200 extend slightly below with the bottom side 145 of the container tray 100 or are substantially flush with the bottom side 145 of the container tray 100 after the blade or cutting device (not shown) traverses across the bottom openings 120 and/or the bottom side 145 of the container tray 100 and simultaneously cuts and trims a plurality of mushroom stems 210.

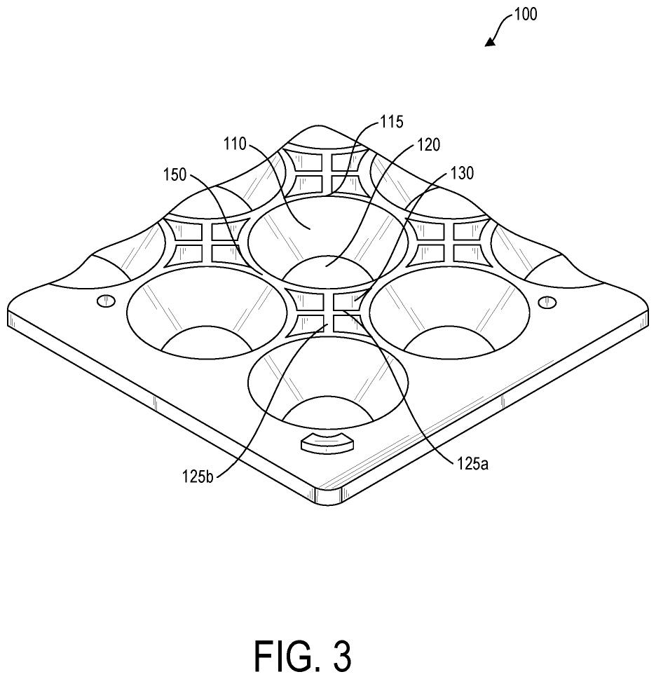

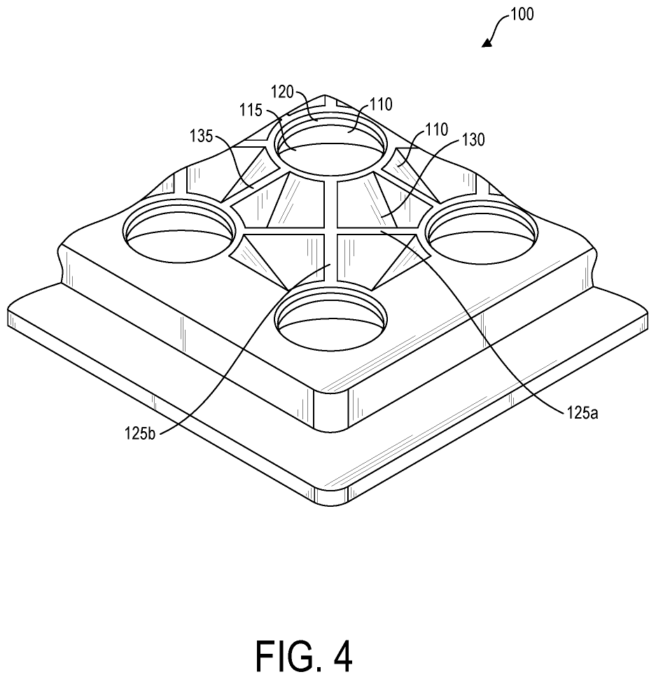

Referring again to FIGS. 3 and 4, FIG. 3 is an enlarged perspective view of a portion of the top side 140 of the container tray 100 containing a plurality of receptacles 105, and FIG. 4 is an enlarged perspective view of a portion of the bottom side 145 of the container tray 100 illustrating some of the same receptacles 105. One receptacle 105 shares a common rim 150 for the top opening 115 with one or more top openings 115 for additional receptacles 105. For example, referring to FIG. 3, one receptacle 105 having a top opening 115 is centrally located within four (4) other top openings 115 for four (4) other receptacles 105 such that the four (4) other receptacles are spaced evenly apart (i.e., 90 degrees apart) around the rim 150 or top circumference of the centrally located receptacle 105. The centrally located receptacle 105 comprises a top opening 115 that has a rim 150, and the four (4) other surrounding top openings 115 each share a portion of the same rim 150 with the centrally located receptacle 105. Referring to FIG. 4, the same centrally located receptacle 105 having a bottom opening 120 is centrally located with four (4) other bottom openings 120 for four (4) other receptacles 105 such that the four (4) other receptacles are spaced evenly apart (i.e., 90 degrees apart) around the circumference of the centrally located receptacle 105. Although FIG. 3 and FIG. 4 depict one receptacle 105 having a top opening 115 that is centrally located among only four (4) other top openings 115 for four (4) other receptacles 105, and the four (4) other surrounding top openings 115 each share a portion of the same rim 150 with the centrally located receptacle 105, it shall be understood that the one receptacle 105 may be centrally located among more than four (4) other top openings 115 for four (4) other receptacles 105, such as five (5) or six (6) or seven (7) or eight (8) other receptacles.

Continuing to refer to FIG. 3 and FIG. 4, there are depicted a plurality of gussets 125a, 125b, 135 extending from the top side 140 of the container tray 100 to the bottom side 145 of the container tray 100. Gussets 125a, 125b also traverse or extend from the rim 150 of one receptacle 105 to the rim of another receptacle 105 as gussets 125a, 125b extend from the top side 140 of the container tray 100 to the bottom side 145 of the container tray 100. And because each gusset 135 extends from a common rim, gusset 135 extends from the top side 140 of the container tray 100 to the bottom side 145 of the container tray 100 . Assuming the two receptacles 105 share a portion of the same rim 150, and the receptacle 105 is funnel shaped from it top opening 115 to is bottom opening 120, the gussets 125a, 125b, 135 may have a triangular shape or a trapezoidal shape as the gussets 125a, 125b, 135 extend from the top side 140 of the container tray 100 to the bottom side 145 of the container tray 100. For example, gusset 135 is not shown on the top side 140 of the container tray in FIG. 3, but gusset 135 is shown on the bottom side 145 of the container tray 100 extending from one receptacle 105 to an adjacent receptacle 105 in FIG. 4 and forming a generally triangular shape. As another example, gussets 125a, 125b are shown both on the top side 140 of the container tray in FIG. 3 and on the bottom side 145 of the container tray 100 extending from one receptacle 105 to an adjacent receptacle 105 and forming a generally trapezoidal shape. In both examples, the gussets 125a, 125b, 135 have either a substantially triangular or trapezoid shape as the gussets 125a, 125b, 135 extend from the top side 140 of the container tray 100 to the bottom side 145 of the container tray 100 because the gussets 125a, 125b, 135 are wider or longer or thicker on the bottom side 145 of the container tray 100 relative to the top side 140 of the container tray 100. That is, the end or side of the triangle or trapezoid disposed on the bottom side of the container tray 100 is the larger side relative to the top side 140 of the container tray 100.

Additionally, the gussets 125a, 125b, 135 create at least four (4) openings 130 spaced evenly apart (i.e., 90 degrees apart) around the circumference of the centrally located receptacle 105 and between the four (4) other top openings 115 for four (4) other receptacles 105 spaced evenly apart (i.e., 90 degrees apart) around the circumference of the centrally located receptacle 105. These openings 130 reduce weight of the tray by decreasing the amount of material needed to manufacture the tray. The openings 130 on the top surface are intentionally left open to allow passage of water/detergent/sanitizer during washing, thereby minimizing the likelihood that the container tray 100 will catch debris which may increase the difficulty in cleaning the mushrooms and the tray. The openings 130 are smaller in size at the top of the side 140 of the tray 100 relative to the bottom side 145 of the tray 100.

Although not shown in the figures, the tray 100 may contain an embedded radio frequency identification (RFID) device or bar code that can provide a means of identifying the harvester who picked the mushrooms, the origin of the mushrooms (crop), and the current location or status of each tray 100. For example, the RFID devices or bar code(s) may be attached or embedded, and logically matched or paired, in any two opposite corners of a tray 100.

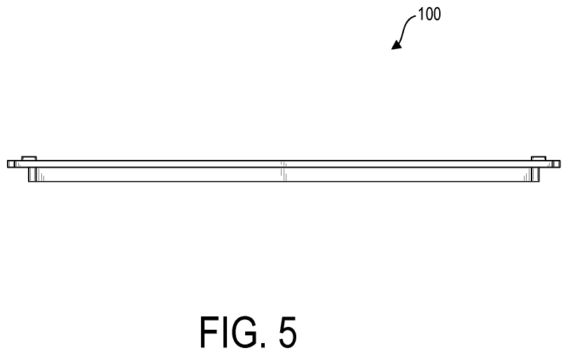

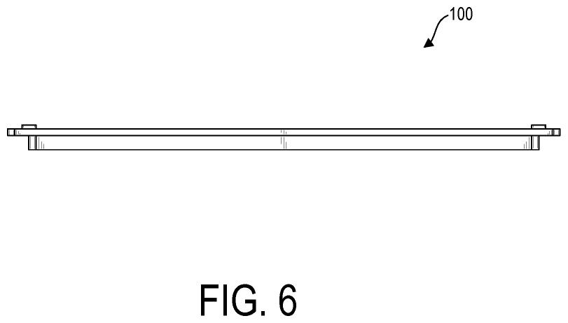

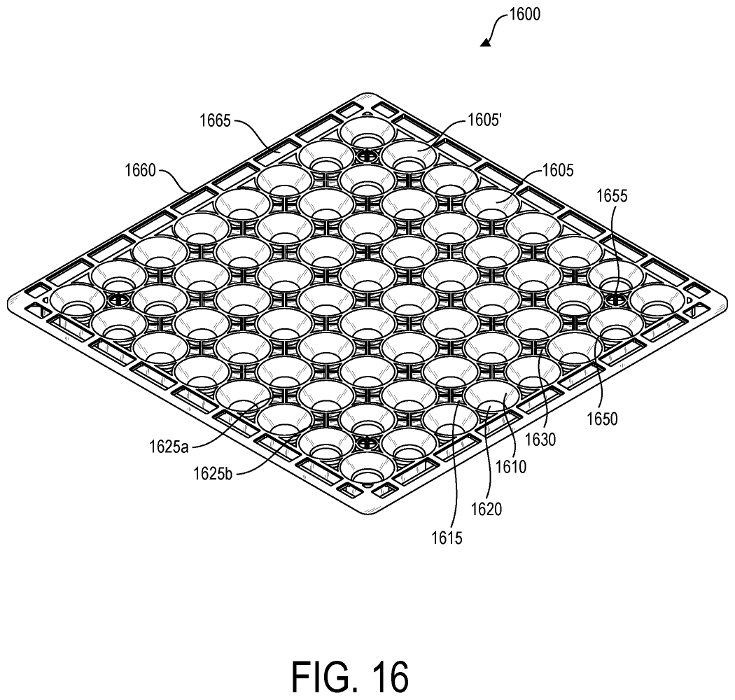

Referring to FIGS. 16-20, there is depicted another example of an empty container tray 1600, in accordance with the present disclosure. The container tray 1600 depicted in FIGS. 16-20 is similar to the container tray 100 depicted in FIGS. 1-8. The container tray 1600 includes a plurality of funnel-shaped receptacles 1605 (or cavities), which are arranged in a series of rows and columns. For example, FIGS. 16, 17, 17A and 19-20 illustrate eight (8) rows and eight (8) columns of receptacles 1605 in the tray 1600, thereby totaling sixty-four (64) receptacles 1605 per tray 1600. Because each receptacle 1605, can retain and store one (1) mushroom, the tray 1600 can retain and store a total of sixty-four (64) mushrooms 200.

Each receptacle 1605 comprises a top opening 1615 on the top side 1640 (or top surface) of the tray 1600, a bottom opening 1620 on the bottom side 1645 (or top surface) of tray 1600, and an angled wall 1610 extending from the top opening 1615 (and the top side 1640) to the bottom opening 1620 (and the bottom side 1645). The wall 1610 is angled similar to the wall of a funnel or open-shaped cone because the top opening 1615 is greater in size than the bottom opening 1620. Both the top opening 1615 and the bottom opening 1620 are circular in shape; hence, the rims of the top opening 1615 and the bottom opening 1620 have respective circumferences and diameters, wherein the diameter and circumference of the top opening 1615 is larger than the diameter and circumference of the bottom opening 1620. Although the top opening 1615 and the bottom opening 1620 are circular, any of the openings may have a different shape, such as oval, triangular, square, rectangular, pentagon, hexagon, octagon, etc. Regardless of the shape of the top opening 1615 and the bottom opening 1620, it may be preferable for the rims of the openings to be chamfered to increase the ease with which the mushrooms release from the receptacle 1605 while the stems extend through the bottom opening 1620.

The receptacle 1605 comprises a top opening 1615 having a diameter (b) and a bottom opening 1620 having a diameter (c), wherein the top opening 1615 is greater than the bottom opening 1620. The container tray 1600 (and the funnel 1605) also has a height (a) measured vertically straight from the top side 1640 of the container tray 1600 to the bottom side 1645 of container tray 1600. Again, the wall 1610 is angled (or tapered inwardly from the top side 1640 to the bottom side 1645 similar to a funnel) because the top opening 1615 is greater in size than the bottom opening 1620. The receptacle 1605, therefore, comprises an angle (α) measured at the intersection of the bottom opening 1620 and the wall 1610, as well as an angle (β) measured at the intersection of the top opening 1620 and the wall 1610. The size(s), such as the dimensions and angles, of the receptacle 1605 in container tray 1600, as shown in FIGS. 16-20, are generally the same as the size(s) of the receptacle 105 in container tray 100 discussed above with respect to FIGS. 14 and 14A. Particularly the heights (a, d), diameters (b, c), and angles (α, β) of the receptacle 1605 in container tray 1600 are the same as the receptacle 105 in container tray 100.

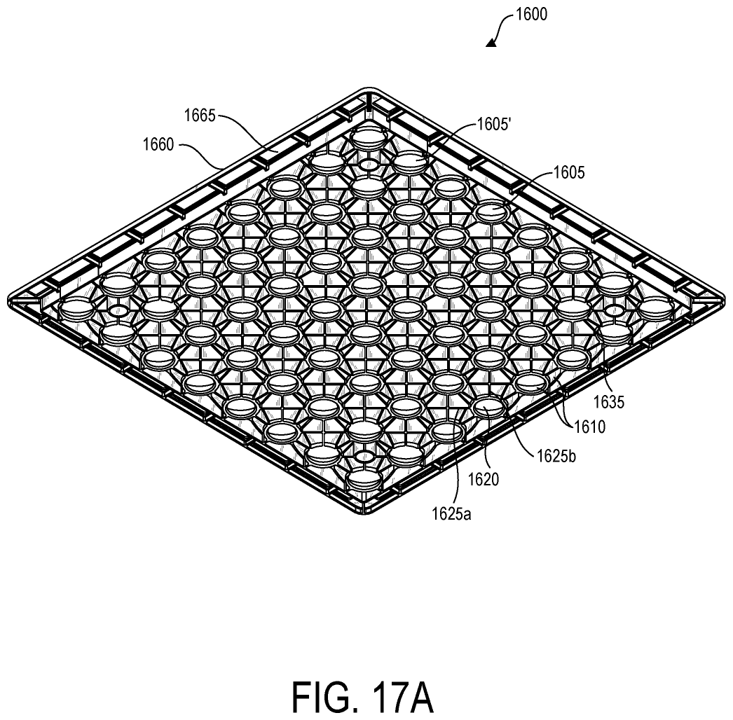

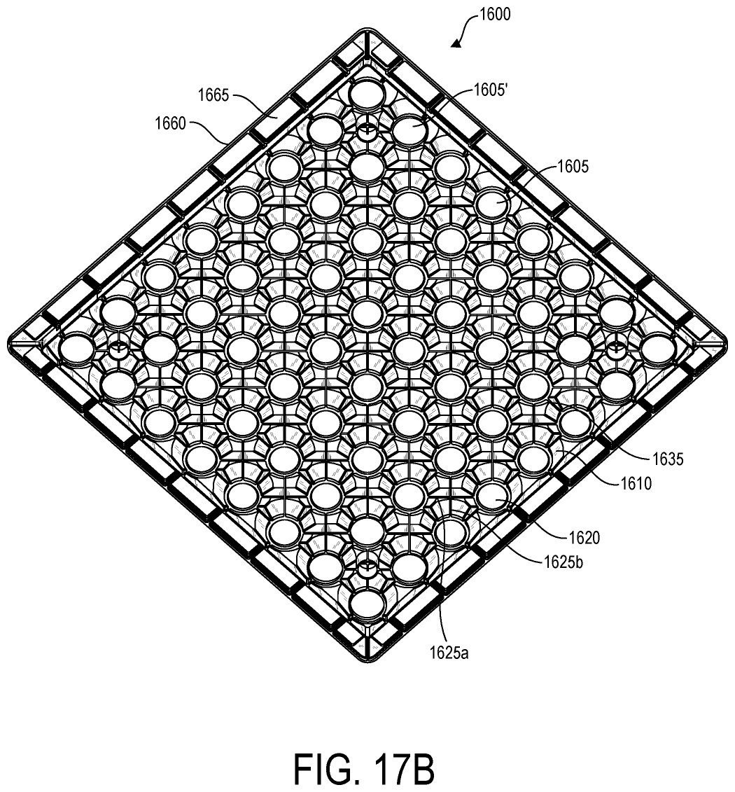

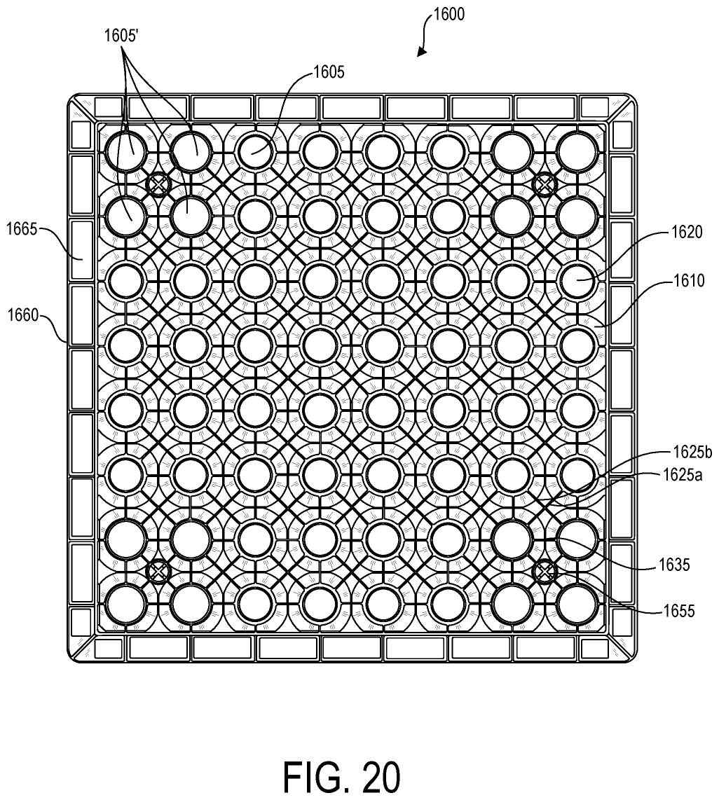

While all of the receptacle 105 in container tray 100 illustrated in FIGS. 1-2 and 9-10 are depicted as having the same size, some of the receptacles 1605′ in container tray 1600 have sizes different from other receptacles 1605. As shown in FIGS. 17B and 20, sixteen (16) of the receptacles 1605′ in the container tray 1600 have a bottom opening 1620 that is greater than the bottom openings 1620 of the remaining forty eight (48) receptacles 1605. Specifically, there are four (4) receptacles 1605′ located in each of the four (4) corners of the container tray 1600, and the bottom openings 1620 for each of those receptacles 1605′ that are greater than the bottom openings 1620 for the other receptacles 1605. That is, four (4) receptacles 1605′ are adjacent one another in the container tray 1600, and the bottom openings 1620 for each of those receptacles 1605′ that are greater than the bottom openings 1620 for the other receptacles 1605. The four (4) adjacent receptacles 1605′ need not be located in corners of the container tray 1600, and may be located in other areas of the container tray 1600. Also, the number of receptacles 1605′ in the container tray 1600 have a bottom opening 1620 being greater than the bottom openings 1620 of the remaining receptacles 1605 may be a number other than four (4), such as one, two, three, five, six, seven, eight or nine.

Referring again to FIGS. 16, 17A, 17B, 19 and 20, there is depicted the container tray 1600 illustrating a plurality of some of the same receptacles 1605. One receptacle 1605 shares a common rim 1650 for the top opening 1615 with one or more top openings 1615 for additional receptacles 1605. For example, one receptacle 1605 having a top opening 1615 is centrally located within four (4) other top openings 1615 for four (4) other receptacles 1605 such that the four (4) other receptacles are spaced evenly apart (i.e., 90 degrees apart) around the rim 1650 or top circumference of the centrally located receptacle 1605. The centrally located receptacle 1605 comprises a top opening 1615 that has a rim 1650, and the four (4) other surrounding top openings 1615 each share a portion of the same rim 1650 with the centrally located receptacle 1605. The same centrally located receptacle 1605 having a bottom opening 1620 is centrally located with four (4) other bottom openings 1620 for four (4) other receptacles 1605 such that the four (4) other receptacles are spaced evenly apart (i.e., 90 degrees apart) around the circumference of the centrally located receptacle 105. Although the figures depict one receptacle 1605 having a top opening 1615 that is centrally located among only four (4) other top openings 1615 for four (4) other receptacles 1605, and the four (4) other surrounding top openings 1615 each share a portion of the same rim 150 with the centrally located receptacle 1605, it shall be understood that the one receptacle 1605 may be centrally located among more than four (4) other top openings 1615 for four (4) other receptacles 105, such as five (5) or six (6) or seven (7) or eight (8) other receptacles.

Continuing to refer to FIGS. 16, 17A, 17B, 19 and 20, there are depicted a plurality of gussets 1625a, 1625b, 1635 extending from the top side 1640 of the container tray 1600 to the bottom side 1645 of the container tray 1600. Gussets 1625a, 1625b also traverse or extend from the rim 1650 of one receptacle 1605 to the rim of another receptacle 1605 as gussets 1625a, 1625b extend from the top side 1640 of the container tray 1600 to the bottom side 1645 of the container tray 1600. And because each gusset 1635 extends from a common rim, gusset 1635 extends from the top side 1640 of the container tray 1600 to the bottom side 1645 of the container tray 1600. Assuming the two receptacles 1605 share a portion of the same rim 1650, and the receptacle 1605 is funnel shaped from it top opening 1615 to is bottom opening 1620, the gussets 1625a, 1625b, 1635 may have a triangular shape or a trapezoidal shape as the gussets 1625a, 1625b, 1635 extend from the top side 1640 of the container tray 1600 to the bottom side 1645 of the container tray 1600. For example, gusset 1635 is shown on the bottom side 1645 of the container tray 1600 extending from one receptacle 1605 to an adjacent receptacle 1605 and forming a generally triangular shape. As another example, gussets 1625a, 1625b are shown both on the top side 1640 of the container tray 1600 and on the bottom side 1645 of the container tray 1600 extending from one receptacle 1605 to an adjacent receptacle 1605 and forming a generally trapezoidal shape. In both examples, the gussets 1625a, 1625b, 1635 have either a substantially triangular or trapezoid shape as the gussets 1625a, 1625b, 1635 extend from the top side 1640 of the container tray 1600 to the bottom side 1645 of the container tray 1600 because the gussets 1625a, 1625b, 1635 are wider or longer or thicker on the bottom side 1645 of the container tray 1600 relative to the top side 1640 of the container tray 1600. That is, the end or side of the triangle or trapezoid disposed on the bottom side of the container tray 1600 is the larger side relative to the top side 1640 of the container tray 1600.

Additionally, the gussets 1625a, 1625b, 1635 create at least four (4) openings 1630 spaced evenly apart (i.e., 90 degrees apart) around the circumference of the centrally located receptacle 1605 and between the four (4) other top openings 1615 for four (4) other receptacles 1605 spaced evenly apart (i.e., 90 degrees apart) around the circumference of the centrally located receptacle 1605. These openings 1630 reduce weight of the tray by decreasing the amount of material needed to manufacture the tray. The openings 1630 on the top surface are intentionally left open to allow passage of water/detergent/sanitizer during washing, thereby minimizing the likelihood that the container tray 1600 will catch debris which may increase the difficulty in cleaning the mushrooms and the tray. The openings 1630 are smaller in size at the top of the side 1640 of the tray 1600 relative to the bottom side 1645 of the tray 1600.

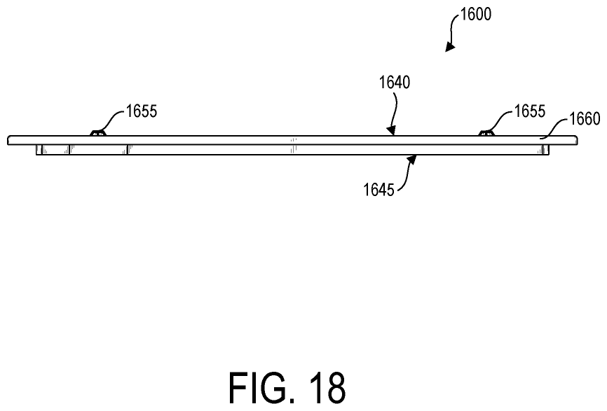

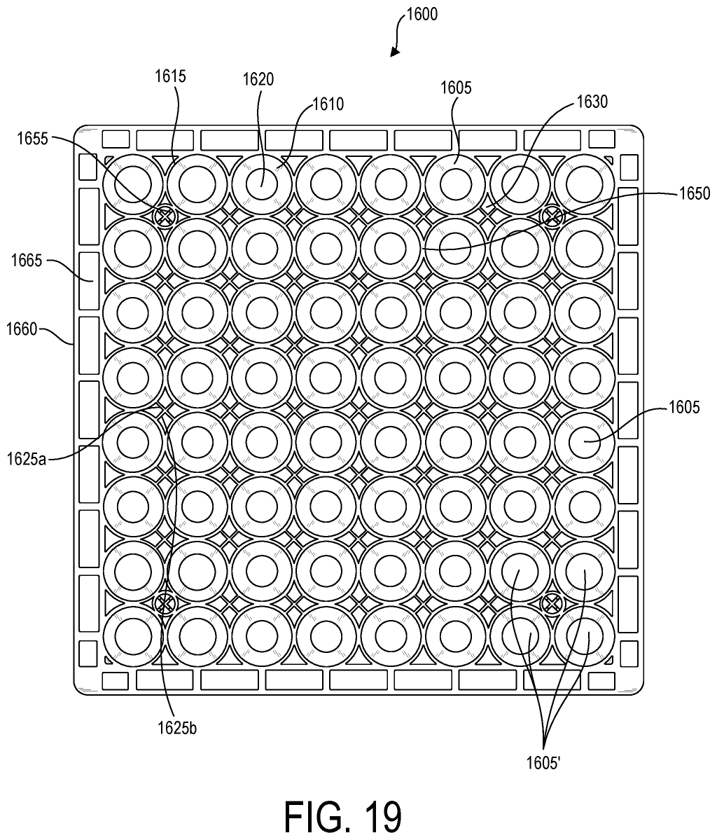

Referring to FIG. 18 is both an end view and side view of the container tray 1600 depicted in FIGS. 16-17 because both end views and both side views of the container tray 1600 are the same due to the fact that the container tray 1600 is symmetrically shaped. Continuing to refer to FIG. 18, the container tray 1600 includes a means for stacking the container trays 1600 on top of one another. The means for stacking the container trays 1600 may include a protrusion 1655 or a plurality of protrusions 1655 extending from the top side 1640 of the container tray 1600. The means for stacking the container trays 1600 may also include a respective number of receptacles 1655 on the bottom side 1645 of the container tray 1600 for receiving the protrusions 1655 extending from the top side 1640 of the container tray 1600 when the container trays 1600 are stacked. Referring to FIGS. 19 and 20, the receptacles 1655 on the bottom side 1645 of the container tray 1600 and the protrusions 1655 extending from the top side 1640 of the container tray 1600 may be centrally disposed among a plurality of receptacles 1605.

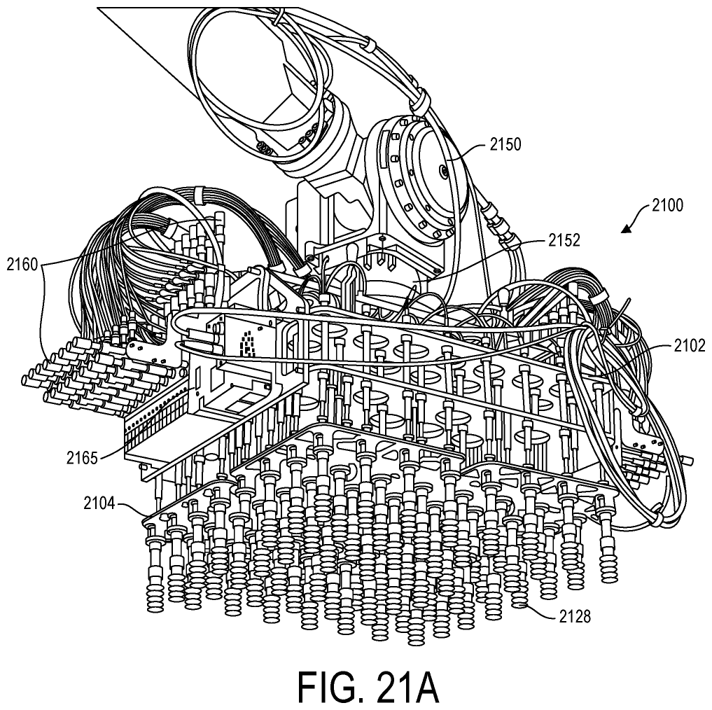

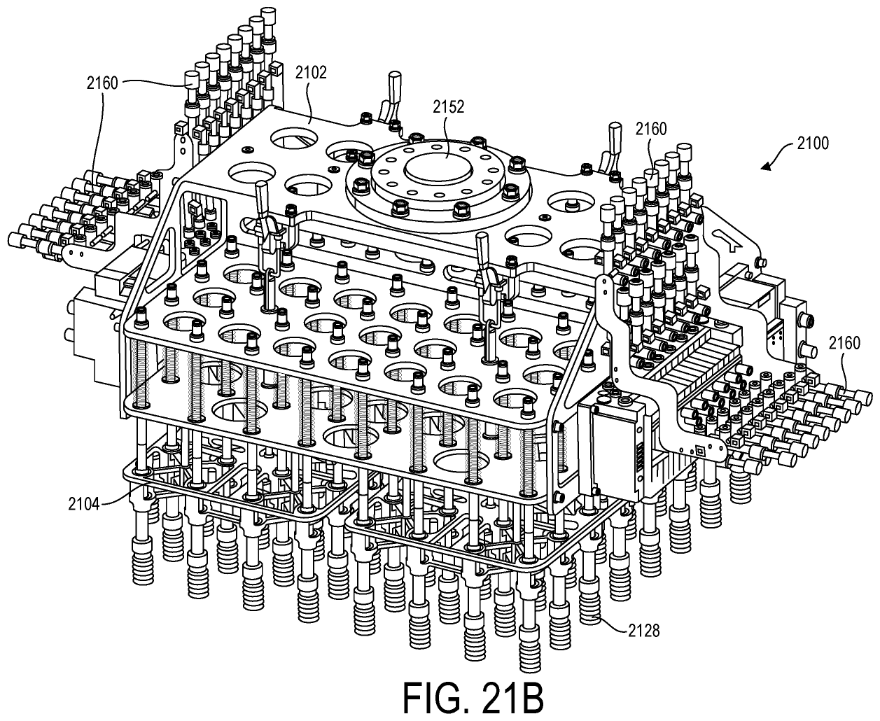

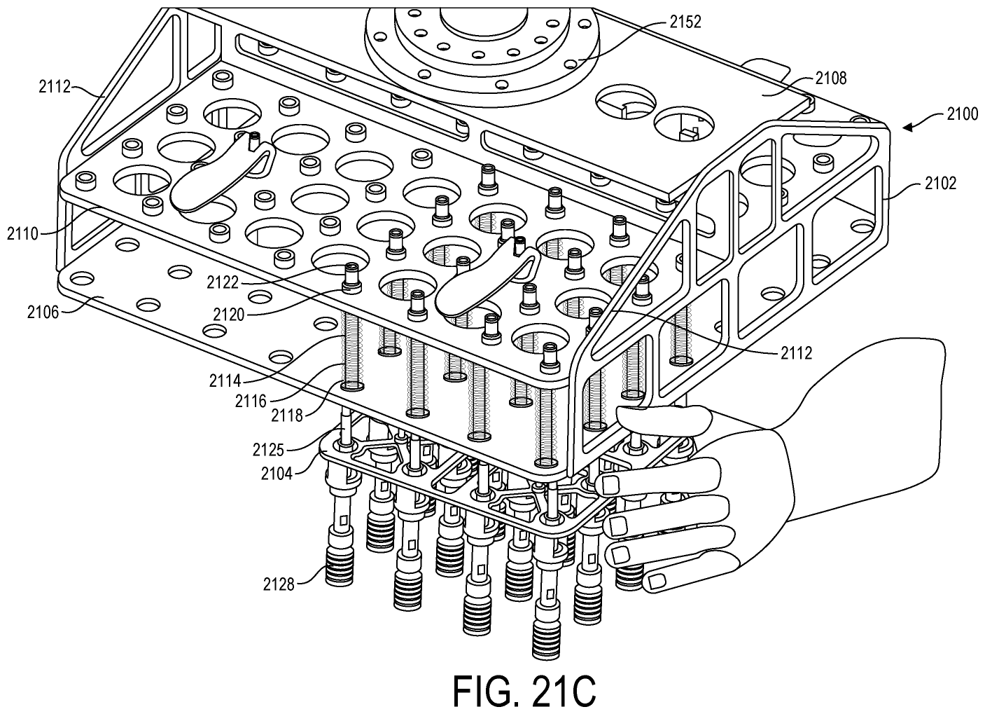

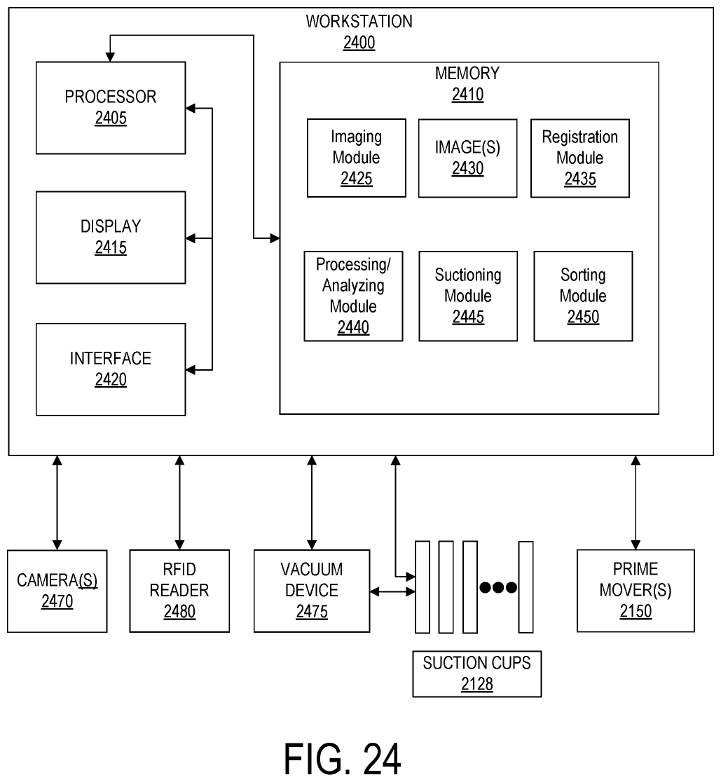

Referring to FIGS. 21A and 21B, there is depicted is a bottom perspective view of a sorting device 2100 and a top perspective view of the sorting device 2100, respectively, with a plurality of sub-assemblies 2104 attached thereto. The sorting device 2100 may also comprise one or more prime movers 2150 or motors (see also FIG. 24) that is/are coupled to the frame 2102 (via a coupler 2152) and/or the plurality of sub-assemblies 2104 to move the frame 2102 and/or the sub-assemblies 2104 in a unidimensional, two-dimensional and/or three-dimensional orientation, as well as transport the mushrooms retained by the suction cups 2128 coupled to the frame 2102 and/or the plurality of sub-assemblies 2104. That is, there may be one or prime movers 2150 coupled to the frame 2102 to move the frame 2012 and/or one or prime movers 2150 coupled to each of the plurality of sub-assemblies 2104 to move the sub-assemblies 2104 and the mushrooms retained by the suction cups 2128. There may also be one or prime movers 2150 (FIGS. 21A and 24) to move the container trays 100, 1600 .

Continuing to refer to FIGS. 21A and 21 B and additional reference to FIG. 24, there are depicted a bank of venturis 2160 and a vacuum device controller 2165 (FIG. 21A). The venturis 2160 and the vacuum device controller 2165 are part of a vacuum device 2475 (FIG. 24). Either one or a pair of venturis 2160 is coupled to each suction cup 2128. The vacuum device controller 2165 is logically coupled to a workstation 2400 (FIG. 24). For example, the vacuum device controller 2165 may be wirelessly coupled to the workstation 2400. The vacuum device controller 2165, in turn, may be logically (e.g., wirelessly) coupled to the venturis 2160. As such, upon the workstation 2400 and/or the vacuum device controller 2165 producing a signal to activate or deactivate a suction cup 2128, the vacuum device controller 2165, delivers fluid, such as pressurized air, to the venturi(s) 2160, thereby activating and/or deactivating a respective suction cup 2128 to retain or release a corresponding mushroom. It shall be understood that a plurality of venturis 2160, and in turn, a corresponding number of suction cups 2128, can be activated and/or deactivated simultaneously by the workstation 2400 and/or the vacuum device controller 2165, thereby retaining and releasing a corresponding plurality of mushrooms.

Referring to FIG. 21C, there is depicted a top perspective view of a portion of the sorting device 2100, in accordance with the present disclosure. For example, FIG. 21A depicts the sorting device 2100 having the prime mover 2150 coupled to the frame 2102 (via a coupler 2152) and the plurality of sub-assemblies 2104 coupled to the frame 2102, and FIG. 21B depicts the sorting device 2100 decoupled from the prime mover 2150 while depicting the plurality of sub-assemblies 2104 coupled to the frame 2102. And FIG. 21C depicts one the of sub-assemblies 2104 coupled to the frame 2102, while other components the sorting device 2100 are omitted from FIG. 21C (in comparison to FIGS. 21A and 21B) for clarity. As such, the sorting device 2100 comprises a frame 2102 and a plurality of sub-assemblies 2104 coupled to the frame 2102. Although only one sub-assembly 2104 is depicted in FIG. 21C, it shall be understood that there can be a plurality (e.g., four) sub-assemblies 2104 coupled to the frame 2102, particularly the bottom of the frame 2102.

Continuing to refer to FIG. 21C, the frame 2102 of the sorting device 2100 may comprise a base plate 2106, a middle plate 2110 and a top plate 2108, wherein the base plate 2106, middle plate 2110 and top plate 2108 are oriented horizontally and separated from one another by one or more distances. The base plate 2106 is disposed below the middle plate 2110 and the top plate 2108. The middle plate 2110 is disposed above the base plate 2106 and below the top plate 2108; that is, the middle plate 2110 is disposed between the base plate 2106 and the top plate 2108. The top plate 2108 is disposed above the middle plate 2110 and the base plate 2106. The base plate 2106 is separated from the middle plate 2110 by a first distance, and the middle plate 2110 and the top plate 2108 are separated by a second distance, wherein the first distance may be less than, equal to or greater than the second distance. The base plate 2106, the middle plate 2110 and the top plate 2108 each have two opposite sides, and those sides are coupled to two side plates 2112, wherein the side plates 2112 are preferably vertically oriented and parallel to one another.

The sorting device 2100 comprises a plurality of sub-assemblies 2104 coupled to the frame 2102 via a plurality of pneumatic rods or lines 2114. For example, the frame 2102 may include a plurality of vertically aligned openings 2118, 2120 to receive the pneumatic rods 2114. The plurality of openings 2118 are in the base plate 2106, and the plurality of openings 2120 are in the middle plate 2110. Each pneumatic rod 2114 extends though the corresponding set of vertically aligned openings 2118, 2120 in the base plate 2106 and the middle plate 2110, respectively. The top 2122 of each pneumatic rod 2114 has an opening to receive a supply of fluid (e.g., air) from the vacuum device or pressure source 2475 (FIG. 24). Because it is preferable for each suction cup 2128 to be individually controlled by workstation 2400 (FIG. 24), it is preferable for each pneumatic rod 2114 (and each suction cup 2128) to be individually coupled to the vacuum device 2475 to receive a supply of pressurized fluid in order to actuate the suction cups 2128. Each pneumatic rod 2114 (and each suction cup 2128) may be directly coupled to the vacuum device 2475 or indirectly coupled to the vacuum device 2475 via a vacuum cylinder pump 2124 or other pneumatically operated device(s) that converts a fluid pressure change to a vertical (or mechanical) displacement.

Again, the sorting device 2100 comprises a plurality of suction cups 2128, and the number of suction cups 2128 corresponds to the same number of funnels 105, 1605 in the container trays 100, 1600 (shown elsewhere). In the examples of the container trays illustrated in this disclosure, each tray has sixty four (64) receptacles. Hence, each container tray can hold sixty four (64) mushrooms, assuming one mushroom is disposed in one receptacle.

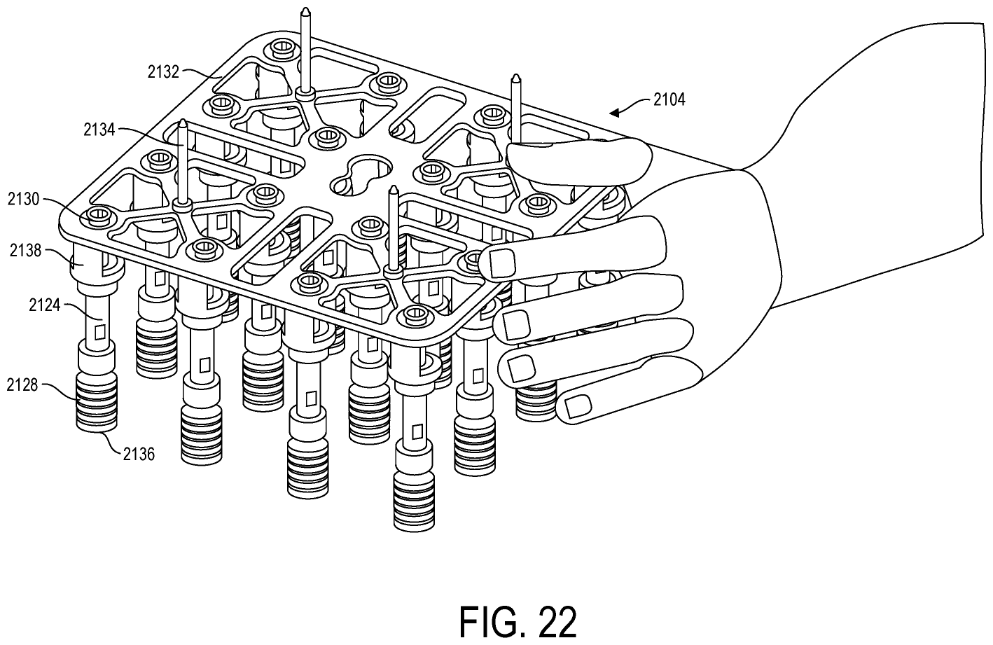

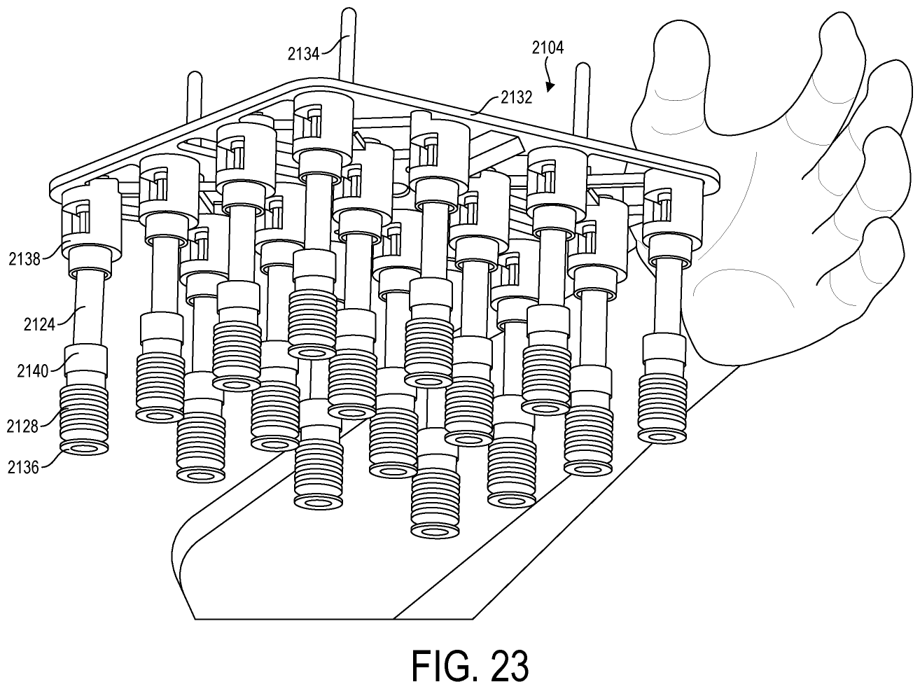

Referring to FIG. 22 and FIG. 23, there is shown one of a plurality of sub-assemblies 2104 of the sorting device 2100, in accordance with the present disclosure, wherein each sub-assembly 2104 comprises one-fourth of the overall number of suction cups 2128. That is, the sorting device 2100 may comprise a total of sixty four (64) suction cups 2128, and if the sorting device 2100 comprises four (4) sub-assemblies 2104, each sub-assembly 2104 will comprise sixteen (16) suction cups 2128. It shall be understood that each sub-assembly 2104 may comprise more or less than sixteen (16) suction cups 2128. For example, it may be desirable to simultaneously pick up a row of four (4) mushrooms, or a row of eight (8) mushrooms, or eight (8) mushrooms arranged in a 4×2 array. If so, the sub-assembly 2104 may comprise a corresponding number and arrangement of suction cups 2128. It may alternatively be desirable to pick up and sort a single mushroom at a time. If so, each sub-assembly 2104 may comprise a single suction cup 2128. The suction cups 2128 will be used to select and pick up the desired number of mushrooms from the container trays 100, 1600 (shown elsewhere) and deposit such mushrooms either directly into retail mushroom containers (e.g., tills or boxes . . . ) or such mushrooms may be loaded into other packaging machinery that will subsequently deposit the mushrooms into containers.

Each suction cup 2128 may have a bellows configuration and an opening 2136, which has a perimeter that mates with the cap portion 205 of the mushroom 200 (shown elsewhere). Upon the suction cup 2128 mating with the cap portion 205 of the mushroom 200, and upon application of a negative pressure via the vacuum cylinder pump 2124, a fluid or pneumatic seal is formed between the opening 2136 of the suction cup 2128 along the perimeter of the suction cup 2128. The mushrooms 200 can then be individually and selectively retained or released by the suction cups 2128. As shown in FIG. 22 and FIG. 23, the sub-assembly 2104 may comprise a frame 2132, a pneumatic rod 2125 coupled to the frame 2132 via a coupling 2138, and another coupling 2140 that connects the pneumatic rod 2125 to the suction cup 2128. The pneumatic rod 2125 and/or the suction cup 2128 may move vertically (e.g., up and/or down) upon a change in pneumatic pressure. Referring again to FIG. 21, the vacuum cylinder pump 2124 is either integral with a pneumatic rod 2125 or coupled to the pneumatic rod 2125 via an opening 2130 in the pneumatic rod 2125, which transports the pressurized fluid to the suction cup 2128.

As discussed above with respect to FIGS. 21A-21C, the sorting device 2100 comprises a plurality of sub-assemblies 2104 coupled to the frame 2102 via one or more rods 2134. Hence, upon the sorting device 2100 moving, all of the sub-assemblies 2104 move in the same direction. For example, upon the sorting device 2100 rotating, tilting and moving vertically or laterally, so do all of the sub-assemblies 2104.

As discussed above, the means for capturing the mushrooms when the mushrooms are disposed within the funnels 105, 1605 in the container trays 100, 1600 may comprise a corresponding plurality of suction cups 2128. This disclosure also envisions using alternative capturing means. For example, an example of an alternative capturing means may include a plurality of barbed spears that are pneumatically activated to pierce and penetrate and capture a corresponding number of mushrooms.

Referring to FIG. 24, there is an exemplary block diagram of the workstation 2400 or console having a control system from which an operator may operate, supervise, oversee and/or manage the sorting device 2100 (shown elsewhere), in accordance with the present disclosure. The workstation 2400 preferably includes a computer system comprising one or more processors 2405 and memory 2410 for storing programs and applications to perform the methods disclosed herein. Memory 2410 may store an imaging module 2425, images 2430, a registration module 2435, a processing/analyzing module 2440, a suctioning module 2445 and a sorting module 2450. The imaging module 2425 may be configured to image the individual mushrooms 200 (shown elsewhere), particularly each of the plurality of the cap portions 205 (from both a top and/or bottom perspective) and/or the stem portions 210 of the corresponding mushrooms 200 in the container trays 100, 1600 (shown elsewhere) with one or more imaging devices 2470, such as one or more cameras 2470. The imaging module 2425 may be configured to image the individual mushrooms 200 while the images are resting in the tray 100, 1600 and distinguish the mushrooms 200 from the trays. Upon completing the imaging of the mushrooms 200, corresponding images 2430 of each of the mushrooms 200 are stored in the memory 2410. The imaging module 2425 and the imaging device 2470 may be configured to obtain and process either two-dimensional (2D) images and/or three-dimensional (3D) images of the individual mushrooms 200.

As mentioned above, each tray 100, 1600 may contain an embedded RFID device or barcode that identifies each tray 100, 1600. The workstation 2400 also includes or is coupled to an RFID reader 2480 or barcode reader so as to scan and/or identify each tray 100, 1600. Upon scanning and/or identifying each tray 100, 1600, the registration module 2435 registers the images 2430 of the mushrooms 200 for the corresponding tray 100, 1600. The registration module 2435 is also configured to register the position of each mushroom 200 in the tray 100, 1600. For example, assuming each tray 100, 1600 comprises a total of 64 receptacles 105, 1605 and there is one mushroom 200 in each receptacle 105, 1605, the registration module 2435 associates and registers each image of a mushroom 200 with a corresponding position in the tray 100, 1600. As shown hereinabove, the tray 100, 1600 may comprise 8 rows of receptacles and 8 columns of receptacles. The registration module 2435 may, therefore, register the images 2430 of the mushrooms 200 according to an X-Y coordinate system, wherein the columns represent the X axis, and the rows represent the Y axis (or vice versa). As such, each image of each mushroom 200 in each tray 100, 1600 is registered in the registration module 2435.

Again, the memory 2410 may include a processing/analyzing module 2440 that is configured to process each of the images 2430 of the mushrooms 200 and analyze the shape, size and/or color of each mushroom 200. For example, the processing/analyzing module 2440 may analyze the shape of a mushroom 200 to determine whether the cap portion 205 of the mushroom 200 is round or oval or another shape. That is, the processing/analyzing module 2440 may be configured to process each of the images 2430 of the mushrooms 200 and analyze the degree of roundness of each mushroom 200. If the degree of roundness is at, above or below a predetermined level of roundness, then the processing/analyzing module 2440 produces a signal indicative that the mushroom is either acceptable or unacceptable, and the mushroom 200 is sorted accordingly.

The processing/analyzing module 2440 may also or alternatively analyze the shape and/or color of a mushroom 200 to determine whether the cap portion 205 of the mushroom 200 is bruised, diseased, or otherwise damaged. That is, the processing/analyzing module 2440 may be configured to determine the color of the cap portion 205 of the mushroom 200 or one or more portions of the mushroom 200, as well as the sizes(s) of such portion(s), to determine whether the cap portion 205 of the mushroom 200 is damaged. For example, one or more damaged portions of the cap portion 205 of the mushroom 200 will be assigned one color (or multiple colors), and one or more undamaged portions of the cap portion 205 of the mushroom 200 will be assigned another color (or multiple colors different than those assigned to the damaged portion(s)). That is, a damaged section of the cap portion 205 of the mushroom 200 will be identified as having a darker color, and an undamaged portion of the cap portion 205 of the mushroom 200 will be identified as having a lighter color relative to one another.

For example, each pixel of an image may be assigned a value associated with a grayscale level, such as between 0 and 255, wherein 0 is darker and 255 is lighter. Each grayscale value will correspond to a damaged, partially damaged or undamaged category depending upon the predetermined thresholds and/or tolerances associated with such scale. There may also be a different scale, as well as different predetermined threshold(s) and/or tolerance(s) for each type of mushroom. For example, a white mushroom may have one scale and a brown mushroom may have another scale. As such, the white mushroom scale will have one set of predetermined threshold(s) and/or tolerance(s), and the brown mushroom scale will have another set of predetermined threshold(s) and/or tolerance(s). Assuming the grayscale level has relatively lower values representative of darkness and relatively higher values representative of lightness, the predetermined threshold(s) for a damaged or partially damaged brown mushroom may be lower than such predetermined threshold(s) for a damaged or partially damaged white mushroom. If, however, the grayscale level has relatively higher values representative of darkness and relatively lower values representative of lightness, then the predetermined threshold(s) for a damaged or partially damaged brown mushroom may be higher than such predetermined threshold(s) for a damaged or partially damaged white mushroom. Additionally, a boundary or edge of the cap portion 205 of the mushroom 200 will be determined based on the distinction of the grayscale values of the pixels.

The image 2430 of the cap portion 205 of the mushroom 200 may be processed to determine the collective percentage of undamaged area of the cap portion 205 of the mushrooms 200 relative to the collective percentage of damaged area of the cap portion 205 of the mushrooms 200, or vice versa. If the ratio of the percentages is above or below a predetermined ratio, then the processing/analyzing module 2440 produces a signal indicative that the mushroom is either acceptable or unacceptable, and the mushroom 200 is sorted accordingly. Additionally or alternatively, the image 2430 of the cap portion 205 of the mushrooms 200 may be processed to determine the amount of damaged area and/or undamaged area of the cap portion 205 of the mushrooms 200. If one of those amounts is above or below a predetermined threshold, then the processing/analyzing module 2440 produces a signal indicative that the mushroom is either acceptable or unacceptable, and the mushroom 200 is sorted accordingly.

The processing/analyzing module 2440 may also analyze the size of a mushroom 200 to determine whether the cap portion 205 of the mushroom 200 is a particular size, such as extra-small, small, medium, large and extra-large. The imaging device 2470 and/or processing/analyzing module 2440 will be calibrated in a manner such the size or area of a single pixel of an image will correlate to a predetermined dimension or proportion, potentially based at least in part upon the distance between the imaging device 2470 and the mushroom being imaged. The processing/analyzing module 2440 will then calculate the cumulative number of pixels the image of the mushroom represents, and the number of pixels will be multiplied by the predetermined dimension of each pixel, thereby producing the size of the cumulative area representative of the mushroom. Additionally, the processing/analyzing module 2440 may convert the area of the pixels that represent the mushroom to a radius and/or diameter for the mushroom. The cumulative area, radius and/or diameter of each of the mushrooms will be compared to a definition table to determine the corresponding size category, such as extra-small, small, medium, large or extra-large.

The processing/analyzing module 2440 may also analyze the size of a mushroom 200 to determine the weight of each mushroom 200 and/or the collective weight of the mushroom 200 in a tray 100, 1600. More specifically, a correlation between a 2D image of the top and/or cap portion 205 of a mushroom and the mushroom's approximate weight may be used. As discussed above, the processing/analyzing module 2440 calculates the cumulative number of pixels of the image representative of each of the mushroom in a tray 100, 1600. Based on the number of pixels of the image(s) representative of each of the mushroom in a tray 100, 1600, the processing/analyzing module 2440 can also determine the area (and corresponding size) for each mushroom in the tray 100, 1600 and determine the cumulative area for all mushrooms in the tray 100, 1600. And based on the area of each mushroom top in the tray 100, 1600 and the aggregate or cumulative area for all mushrooms in the tray 100, 1600, the processing/analyzing module 2440 can also determine the size and weight of each mushroom in the tray 100, 1600 and determine the cumulative weight for all mushrooms in the tray 100, 1600.

The weight calculation for of each mushroom in the tray 100, 1600 and the cumulative weight calculation for all mushrooms in the tray 100, 1600 can also be a function of the stem length. For example, as discussed above with respect to FIGS. 13A, 13B, 14 and 14A, each receptacle 105 has a predetermined size and configuration, such as the height (a), the diameter (b) of the top opening, and the diameter (c) of the bottom opening 120, angle (α) and angle (β). Based on the predetermined size and configuration of the receptacle 105, the length of the stem 210 of the mushroom 200 is estimated because the stem 210 will be cut at the bottom of the tray or a predetermined distance from the bottom of the tray. The estimated length of the stem 210 may also be adjusted based on the size of the top and/or cap portion 205 of a mushroom 200. The estimated length of the stem 210 may also be adjusted based on size or diameter of the stem 210 of a mushroom 200, which can be obtained from the bottom view of the mushrooms. Hence, the processing/analyzing module 2440 may determine the weight of each mushroom 200 and/or the collective weight of the mushrooms 200 in a tray 100, 1600 based upon the 2D image of the top and/or cap portion 205 of a mushroom, the estimated length of the stem, and/or an image of the stem. Determining the individual weight of each mushroom allows the workstation 2400 and/or suction cups 2128 to choose which mushroom to remove from the tray 100, 1600 when sorting the mushrooms based on their respective weights.

The imaging device(s) 2470 may take images of both the top view of the mushroom 200 and bottom view of the mushroom 200. As discussed above, from a top view or top perspective of the mushroom 200, the imaging device(s) 2470 will capture the cap portion 205. From a bottom view or bottom perspective of the mushroom 200, the imaging device(s) 2470 will capture the stem 210 of the mushroom 200 and/or the lamella or gill portion of the mushroom 200. The lamella, or gill, is a papery hymenophore rib under the cap of some mushroom species, most often but not always agarics. Hence, as an alternative or additional example, the processing/analyzing module 2440 may analyze the shape and/or color of the gill of a mushroom 200 to determine whether the mushroom 200 is bruised, diseased, or otherwise damaged. That is, the processing/analyzing module 2440 may be configured to determine the color of the gill of the mushroom 200, as well as the sizes(s) of such portion(s), to determine whether the gill of the mushroom 200 is bruised, diseased, or otherwise damaged. For example, one or more damaged portions of the gill of the mushroom 200 will be assigned one color (or multiple colors), and one or more undamaged portions of the gill of the mushroom 200 will be assigned another color (or multiple colors different than those assigned to the damaged portion(s)).

The image 2430 of the gill of the mushrooms 200 may be processed to determine the collective percentage of undamaged area of the gill of the mushrooms 200 relative to the collective percentage of damaged area of the gill of the mushrooms 200, or vice versa. If the ratio of the percentages is above or below a predetermined ratio, then the processing/analyzing module 2440 produces a signal indicative that the mushroom is either acceptable or unacceptable, and the mushroom 200 is sorted accordingly. Additionally or alternatively the image 2430 of the gill of the mushroom 200 may be processed to determine the amount of damaged area and/or undamaged area of the gill of the mushroom 200. If one of those amounts is above or below a predetermined amount, then the processing/analyzing module 2440 produces a signal indicative that the mushroom is either acceptable or unacceptable, and the mushroom 200 is sorted accordingly. For example, if a mushroom exceeds one or more thresholds for discoloration it will be left in the tray and dumped out as refuse further down the processing line.

The processing/analyzing module 2440 may analyze the size of the gill to determine whether the cap portion 205 of the mushroom 200 is a particular size, such as extra-small, small, medium, large and extra-large. The imaging device 2470 and/or processing/analyzing module 2440 will be calibrated in a manner such the size or area of a single pixel of an image will correlate to a predetermined dimension or proportion, potentially based at least in part upon the distance between the imaging device 2470 and the mushroom being imaged. The processing/analyzing module 2440 will then calculate the cumulative number of pixels the image of the mushroom represents, and the number of pixels will be multiplied by the predetermined dimension of each pixel, thereby producing the size of the cumulative area representative of the mushroom. Additionally, the processing/analyzing module 2440 may convert the area of the pixels that represent the mushroom to a radius and/or diameter for the mushroom. The cumulative area, radius and/or diameter of each of the mushrooms will be compared to a definition table to determine the corresponding size category, such as extra-small, small, medium, large or extra-large.

The processing/analyzing module 2440 may also produce a signal indicative that the mushroom 200 is either acceptable or unacceptable after analyzing both the cap portion 205 and the gill of the mushroom 200. That is, the processing/analyzing module 2440 may produce a composite signal based on the images of both the top view of the mushroom 200 and bottom view of the mushroom 200. The composite signal may be based on the size of the cap portion 205 in the image of the cap portion 205, the size of the cap portion 205 in the image of the gill, the percentage of undamaged area of the cap portion 205 relative to the collective percentage of damaged area of the cap portion 205, the percentage of undamaged area of the gill relative to the collective percentage of damaged area of the gill, or any combination thereof. Additionally, each of the foregoing components of the composite signal may be weighted the same or differently from one another.

The processing/analyzing module 2440 may analyze the shape and/or color of a mushroom 200 to determine whether the stem 210 of the mushroom 200 is damaged. The processing/analyzing module 2440 may analyze the size of a mushroom 200 to determine whether the stem 210 of the mushroom 200 is a particular size, such as extra-small, small, medium, large and extra-large.

Again, the processing/analyzing module 2440 may analyze the size, shape, color, and/or other distinguishing feature(s) of the cap portion 205 of the mushroom 200, the size, shape, color, and/or other distinguishing feature(s) of the stem 210 of the mushroom 200 or both the size, shape, color, and/or other distinguishing feature(s) of the cap portion 205 of the mushroom 200 of the cap portion 205 and the stem 210 of the mushroom 200 or any combination thereof. For size recognition registration, a distinctive size or size template can be employed to obtain the size information from the cap portion 205 and/or the stem 210 of the mushroom 200. For shape recognition registration, a distinctive shape or shape template can be employed to obtain the shape information from the cap portion 205 and/or the stem 210 of the mushroom 200. For color recognition registration, a distinctive color or color template can be employed to obtain the color information from the cap portion 205 and/or the stem 210 of the mushroom 200. For other distinguishing feature recognition registration, other distinguishing feature templates can be employed to obtain the corresponding feature information from the cap portion 205 and/or the stem 210 of the mushroom 200.

Alternatively or in addition to using templates, as discussed in the previous paragraph, an algorithm can be employed to analyze (e.g., compare and contrast) the size, shape, color, and/or other distinguishing feature(s) of the cap portions 205 and/or stems 210 of the mushrooms 200 in each tray 100, 1600 or among trays 100, 1600.

A veil or velum is a temporary, thin membrane layer that covers the cap portion 205 and the stem 210 or stalk of an immature mushroom. Veils typically fall into two categories: a partial veil; and a universal veil. A partial veil isolates and protects the developing spore-producing surface, represented by gills or tubes, found on the lower surface of the cap. A partial veil extends from the stem surface to the cap edge. The partial veil disintegrates once the fruiting body has matured and the spores are ready for dispersal. A universal veil is a temporary membranous tissue that fully envelops immature fruiting bodies of certain gilled mushrooms.

The processing/analyzing module 2440 may also evaluate the veil of the mushroom to make a veil determination. The processing/analyzing module 2440 may make a veil determination using a similar method to determine whether the veil constitutes a diseased or damaged area of the cap. As discussed above, from a top view or top perspective of the mushroom 200, the imaging device(s) 2470 will capture the cap portion 205 and/or the veil. From a bottom view or bottom perspective of the mushroom 200, the imaging device(s) 2470 will capture the stem 210 of the mushroom 200 and/or the lamella or gill portion of the mushroom 200 and/or the veil (e.g., partial veil). Hence, as an alternative or additional example, the processing/analyzing module 2440 may analyze the shape and/or color of the veil of a mushroom 200 to determine whether the mushroom 200 is bruised, diseased, or otherwise damaged. That is, the processing/analyzing module 2440 may be configured to determine the color of the veil of the mushroom 200, as well as the sizes(s) of veil, to determine whether the veil of the mushroom 200 is indicative that the mushroom 200 is bruised, diseased, or otherwise damaged. For example, one or more portions of the veil of the mushroom 200 will be assigned one color (or multiple colors), and one or more undamaged portions (e.g., gill) of the mushroom 200 will be assigned another color (or multiple colors different than those assigned to the damaged portion(s)).

The image 2430 of the veil of the mushrooms 200 may be processed to determine the collective percentage of undamaged area of the mushroom 200 relative to the collective percentage of damaged area of the mushrooms 200, or vice versa, based on the presence of the veil. If the ratio of the percentages is above or below a predetermined ratio, then the processing/analyzing module 2440 produces a signal indicative that the mushroom is either acceptable or unacceptable, and the mushroom 200 is sorted accordingly. Additionally or alternatively the image 2430 of the veil of the mushroom 200 may be processed to determine the amount of damaged area and/or undamaged area of the mushroom 200. If one of those amounts is above or below a predetermined amount, then the processing/analyzing module 2440 produces a signal indicative that the mushroom is either acceptable or unacceptable, and the mushroom 200 is sorted accordingly. For example, if a mushroom exceeds thresholds for discoloration it will be left in the tray and dumped out as refuse further down the processing line.

As discussed above, the memory 2410 within the workstation 2400 may comprise a suctioning module 2445 and a sorting module 2450. The suctioning module 2445 is logically coupled to the vacuum device 2475 and the suction cups 2128, which are in turn both logically, mechanically and/or fluidly coupled to one another. The suctioning module 2445 communicates with the vacuum device 2475 and/or the suction cups 2128 to remove the mushrooms 200 from each tray 100, 1600. And the sorting module 2450 is logically coupled to and communicates with the prime movers 2485 to move the imaging device (e.g., camera) 2470, the trays 100, 1600 and the mushrooms 200, and sort the mushrooms 200 removed from each tray 100, 1600 (or move each tray) as discussed in more detail below. Although FIG. 24 illustrates the suctioning module 2445 and the sorting module 2450 as two separate modules, they may be combined into one module.

Workstation 2400 may also include a display 2415 for viewing the images 2430 of the mushrooms 200. Display 2415 may also permit a user to interact with the workstation 2400 and its components and functions (e.g., touchscreen, graphical user interface, etc.), or any other element within the system. This is further facilitated by an interface 2420 which may include a keyboard, mouse, a joystick, a haptic device, or any other peripheral or control to permit user feedback from and interaction with the workstation 2400.

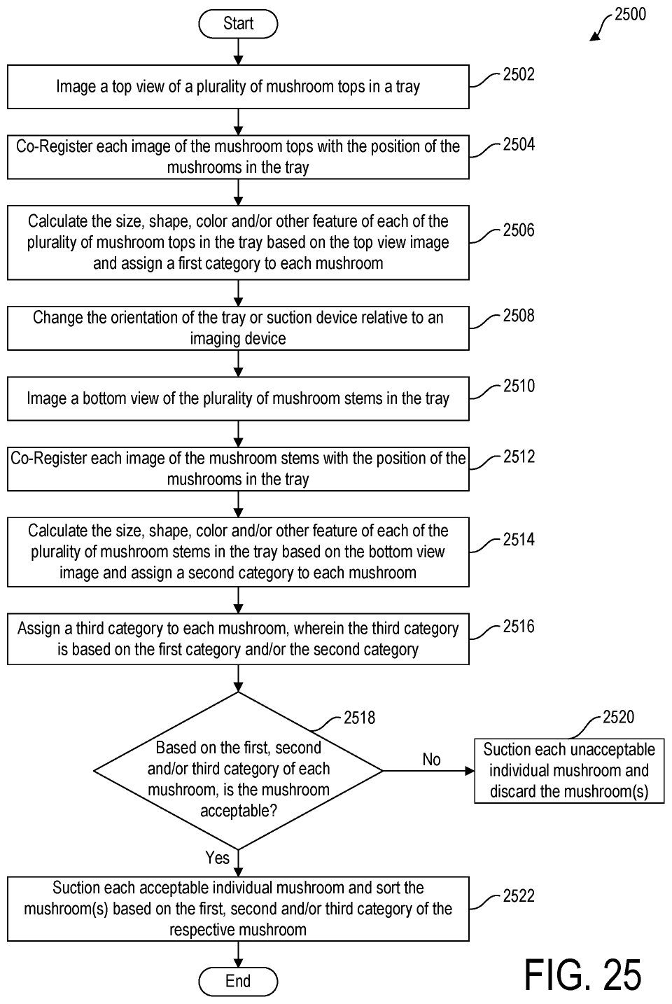

Referring to FIG. 25, there is depicted a flow diagram of an example of a method 2500 of operating the workstation 2400 and sorting device 2100 (both shown elsewhere), in accordance with the present disclosure. That is, the workstation 2400 operates the sorting device 2100 according to this method 2500 in order to remove the mushrooms 200 from each tray 100, 1600 and while or upon removing the mushrooms 200 from each tray 100, 1600, separating, sorting and/or transporting the mushrooms 200 according to their respective size, shape, color, and/or other distinguishing feature(s) of the cap portions 205 and/or stems 210 of the mushrooms 200 in each tray 100, 1600 and/or the weight of the mushrooms 200. Additionally, and/or alternatively, a non-transitory computer-readable medium (e.g., memory within the computing system of the workstation 2400) may include instructions that when executed by one or more processors (e.g., processors within the computing system) may cause the processors to perform the steps of the method 2500.

Step 2502 may comprise imaging a top view of a plurality of the cap portions 205 of the mushrooms 200 while the mushrooms 200 are disposed in a tray 100, 1600 as the tray is oriented relative to the imaging device (e.g., camera) 2470 using a prime mover 2485. For example, the imaging device (e.g., camera) 2470 may be located and disposed over the tray 100, 1600 and mushrooms 200. Step 2504 may comprise co-registering each image of the mushroom cap portions 205 with the position of the mushrooms 200, particularly with the position of the mushrooms 200 in the tray 100, 1600. For example, the trays 100, 1600 discussed above may each have sixty-four (64) receptacles 105. And each receptacle 105 has an X and Y and Z coordinate or coordinate system associated with it. So, co-registering each image of the mushroom cap portions 205 with the position of the mushrooms 200 in the tray may include associating or correlating each receptacle 105 and/or the corresponding mushroom 200 in such receptacle 105 with a position having an X and Y and Z coordinate or coordinate system associated with it.

Step 2506 may comprise calculating or determining the size, shape, color, and/or other distinguishing feature(s) of the cap portions 205 of the plurality of mushrooms 200 in the tray 100, 1600 based on the top view images 2430 of the cap portion 205 of the mushrooms 200. For example, the sizes of the mushrooms may be determined to be extra-small, small, medium, large, extra-large, etc. The sizes of the mushrooms may also be determined the weight of the mushrooms 200 in conjunction with shape, color, and/or other distinguishing feature(s) of the cap portions 205 of the plurality of mushrooms 200 in the tray 100, 1600 based on the top view images 2430 of the cap portion 205 of the mushrooms 200.

Step 2506 may also comprise assigning a first category to each mushroom 200 based on or according to the size, shape, color, and/or other distinguishing feature(s) of the cap portions 205 of the plurality of mushroom 200 (or the images thereof) as determined by the processing/analyzing module 2440 (and/or in conjunction with the weight of the mushrooms 200). For example, the first category may be size, which is determined by analyzing the circumference of each of the cap portions 205 of the plurality of mushroom 200 from a top perspective as discussed above.

Continuing to refer to FIG. 25, step 2508 may comprise altering the orientation of the tray 100, 1600 or sorting device 2100 (or sub-assembly 2104) relative to the imaging device (e.g., camera) 2470, altering the orientation of the imaging device (e.g., camera) 2470 relative to the tray 100, 1600 or sorting device 2100 (or sub-assembly 2104), using an additional imaging device or all of the above. The movement and orientation of the imaging device (e.g., camera) 2470, the tray 100, 1600 and/or sorting device 2100 (or sub-assembly 2104) relative to one another may be accomplished by the imaging module 2425, the sorting module 2450 or another module (such as an orientation module—not shown), which is logically coupled to and communicates with the prime movers 2485 to move and orient the imaging device (e.g., camera) 2470, the tray 100, 1600 and/or sorting device 2100 (or sub-assembly 2104) in or to a desirable position to image the mushrooms. Mushrooms will be imaged from a top perspective while remaining in the funnel tray 100, 1600, and then the mushrooms will be imaged from a bottom perspective. When imaging the mushroom from a bottom perspective, the mushroom will either be imaged while remaining in the funnel tray or prior to being imaged from such perspective, the mushrooms will be removed from the funnel tray while being held by the sorting device 2100, including the sub-assembly(s) 2104, pneumatic rod(s) 2114 and/or suction cup(s) 2128. When imaging the mushroom from a bottom perspective, either the same camera used to image the mushroom from a top perspective or a different camera configured to image the mushroom from a bottom perspective or both cameras may be used. Imaging the mushrooms from a bottom perspective while being removed from the funnel tray and while being held by the sorting device 2100 improves the line of sight of the mushrooms because the funnel tray may obscure a portion of the bottom view of the mushrooms if the mushrooms are imaged from a bottom perspective while remaining in the funnel tray.

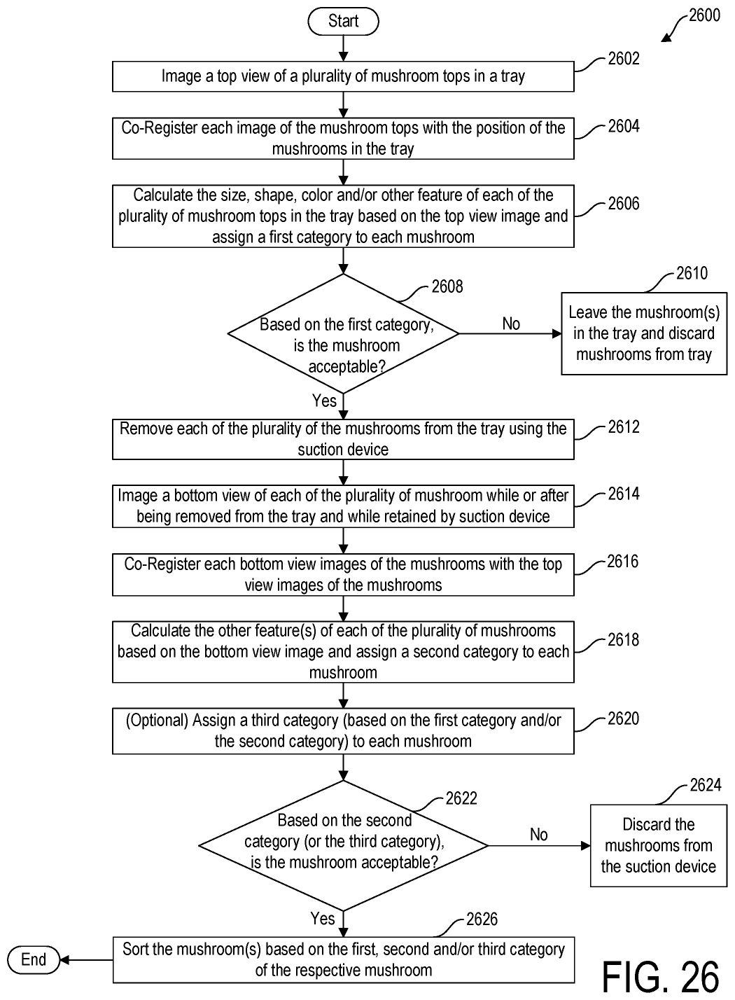

Step 2510 may comprise imaging a bottom view of a plurality of the mushrooms 200 including the stems 210 and the gills and other parts of the bottom portion of the mushrooms 200 while the mushrooms 200 are disposed in a tray 100, 1600 or after being removed from the tray 100, 1600 and while being held by the sorting device 2100, including the sub-assembly(s) 2104, pneumatic rod(s) 2114 and/or suction cup(s) 2128. For example, each pixel of the bottom view of the mushroom 200 will be assigned a grayscale value, and each grayscale value will correspond to a stem, a gill, a veil, or other part of the bottom portion of the mushroom, such as a damaged or undamaged portion. Step 2512 may comprise co-registering each image of the bottom view of the mushroom 200 with the position of the mushrooms 200 in the tray. Step 2514 may comprise calculating or determining the size, shape, color, and/or other distinguishing feature(s) of the different parts of the bottom, such as the stems 210, of the plurality of mushrooms 200 in the tray 100, 1600 based on the bottom view images 2430 of the mushrooms 200 (and/or in conjunction with the weight of the mushrooms 200). Step 2514 may also comprise assigning a second category to each mushroom 200 based on or according to the size, shape, color, and/or other distinguishing feature(s) or part(s) of the bottom of each of the mushrooms 200 other than the stems 210 of the plurality of mushroom 200 (or the images thereof) as determined by the processing/analyzing module 2440 based on the bottom view images 2430 (and/or in conjunction with the weight of the mushroom 200). For example, the second category may be related to the presence, absence and/or quality of the gills of the mushroom as discussed below with respect to FIG. 26.

Step 2516 may comprise assigning a third category to each mushroom 200, wherein the third category is based on the first category and/or the second category or a combination of the size, shape, color, and/or other distinguishing feature(s) of the cap portions 205 of the plurality of mushroom 200 and one or more bottom parts of the plurality of mushroom 200 (or the images thereof) and/or based on the weight of the mushrooms 200. For example, the third category may be based on a weighted average of the first category and/or the second category, wherein the weight of the first category may be the same (e.g., 50% for the first category and 50% for the second category) or different than the second category. Assuming the weight of the first category is different than the weight of the second category, the weight of the first category may be greater than the weight of the second category, such as about 95%, 90%, 85%, 80%, 75%, 70%, 65%, 60%, 55% for the first category and 5%, 10%, 15%, 20%, 25%, 30%, 35%, 40% and 45% for the second category, or the weight of the second category may be greater than the weight of the first category, such as about 95%, 90%, 85%, 80%, 75%, 70%, 65%, 60%, 55% for the second category and 5%, 10%, 15%, 20%, 25%, 30%, 35%, 40% and 45% for the first category.

As discussed above, the image 2430 of the bottom view of the mushrooms 200 may be processed to determine the collective and respective percentages of the different parts (e.g., stem, gills, veil, etc.) of the bottom portion of the mushrooms 200. The image 2430 of the bottom view of the mushrooms 200 may also be processed to determine the collective and/or respective percentages of the undamaged areas of bottom parts of the mushroom 200 relative to the collective and/or respective percentage of damaged area of the different parts of the bottom of the mushrooms 200, or vice versa. As such, the third category may be based on the size, shape, color, and/or other distinguishing feature(s) of the cap portions 205 of the mushroom 200 viewed from a top perspective in combination with the size, shape, color, and/or other distinguishing feature(s) of a bottom portion of the mushroom (e.g., the stem, the gill, the veil of the mushroom) viewed from a bottom perspective and/or based on the weight of the mushrooms 200 in conjunction with the forgoing features or regardless of such features. For example, the third category may be based on a weighted average of a value assigned to the cap portions 205 of the mushroom 200 viewed from a top perspective and a value assigned to the stem or the gill or the veil of the mushroom 200 viewed from a bottom perspective, wherein the weight of the value assigned to the cap portions 205 may be the same (e.g., 50% for the cap portion value and 50% for the gill value) or different than the value assigned to the stem or the gill or the veil. Assuming the weight of the cap portion value is different than the weight of the stem, gill or veil value, the weight of the cap portion value may be greater than the weight of the stem, gill or veil value, such as about 95%, 90%, 85%, 80%, 75%, 70%, 65%, 60%, 55% for the cap portion value and 5%, 10%, 15%, 20%, 25%, 30%, 35%, 40% and 45% for the stem, gill or veil value, or the weight of the stem, gill or veil value may be greater than the weight of the cap portion value, such as about 95%, 90%, 85%, 80%, 75%, 70%, 65%, 60%, 55% for the stem, gill or veil value and 5%, 10%, 15%, 20%, 25%, 30%, 35%, 40% and 45% for the cap portion value.

Continuing to refer to FIG. 25, step 2518 may comprise determining whether each of the plurality of mushrooms 200 is acceptable based on the category (e.g., first category, second category or third category) assigned to such mushroom. If a mushroom 200 is determined to be unacceptable, then a corresponding suction cup 2128 (upon activation of the vacuum device 2475 by the suctioning module 2445)), will suction the unacceptable mushroom 200 from the tray and release the mushroom 200, after movement of the sorting device (controlled by the sorting module 2450 and prime mover(s) 2485) over a container designated for unacceptable mushrooms, such that all unacceptable mushrooms 200 are placed in one or more similar containers designated for discarded or recycled mushrooms. If a mushroom 200 is determined to be acceptable, then a corresponding suction cup 2128 (via activation of the vacuum device), will suction the acceptable mushroom 200 from the tray and release the mushroom 200, after movement of the sorting device over a container assigned a particular designation such that acceptable mushrooms 200 having the same designation are placed in one or more similar designated containers. For example, upon determining that the mushroom 200 is acceptable, the mushroom may be suctioned and deposited in a container designated for extra-small, small, medium, large or extra-large mushrooms. Similarly, the mushroom 200 may be determined to be partially acceptable, and if so, the mushroom may be suctioned and deposited in a container designated for slicing mushrooms.

Referring to FIG. 26, there is depicted a flow diagram of another example of a method 2600 of operating the workstation 2400 and sorting device 2100 (both shown elsewhere), in accordance with the present disclosure. That is, the workstation 2400 operates the sorting device 2100 according to this method 2600 in order to remove the mushrooms 200 from each tray 100, 1600 (shown elsewhere) and while or upon removing the mushrooms 200 from each tray 100, 1600, sorting, transporting and/or separating the mushrooms 200 according to their respective size, shape, color, and/or other distinguishing feature(s) of the cap portions 205 and/or bottom portions of the mushrooms 200 in each tray 100, 1600 and/or the weight of the mushrooms 200 in conjunction with shape, color, and/or other distinguishing feature(s) of the cap portions 205 and/or bottom portion of the plurality. Additionally, and/or alternatively, a non-transitory computer-readable medium (e.g., memory within the computing system of the workstation 2400) may include instructions that when executed by one or more processors (e.g., processors within the computing system) may cause the processors to perform the steps of the method 2600.

Step 2602 may comprise imaging a top view of a plurality of the cap portions 205 of the mushrooms 200 while the mushrooms 200 are disposed in a tray 100, 1600. Step 2604 may comprise co-registering each image of the mushroom cap portions 205 with the position of the mushrooms 200, particularly the position of the mushrooms 200 in the tray 100, 1600. For example, the trays 100, 1600 discussed above may each have sixty-four (64) receptacles 105. And each receptacle 105 has an X and Y and Z coordinate or coordinate system associated with it. So, co-registering each image of the mushroom cap portions 205 with the position of the mushrooms 200 in the tray may include associating or correlating each receptacle 105 and/or the corresponding mushroom 200 in such receptacle 105 with a position having an X and Y and Z coordinate or coordinate system associated with it.

Step 2606 may comprise calculating or determining the size, shape, color, and/or other distinguishing feature(s) of the cap portions 205 of the plurality of mushrooms 200 in the tray 100, 1600 based on the top view images 2430 of the cap portion 205 of the mushrooms 200. For example, the sizes of the mushrooms may be determined to be extra-small, small, medium, large, extra-large, etc. As discussed above, each pixel of the cap portion 205 of the mushroom 200 will be assigned a grayscale value. And the size of the mushroom may be determined by calculating the number of pixels that have the same or similar grayscale value. That is, an extra-small mushroom may have a number of pixels between the range of a and b, a small mushroom may have a number of pixels between the range of c and d, a medium mushroom may have a number of pixels between the range of e and f, a large mushroom may have a number of pixels between the range of g and h, and an extra-large mushroom may have a number of pixels between the range of i and j, wherein a to j are predetermined values. The overall size or categorization of the mushrooms may also be adjusted and/or determined by the weight of the mushrooms 200 in conjunction with the forgoing.

Step 2606 may also comprise assigning a first category to each mushroom 200 based on or according to the size, shape, color, and/or other distinguishing feature(s) of the cap portions 205 of the plurality of mushrooms 200 (or the images thereof) as determined by the processing/analyzing module 2440. For example, the first category may be size, which is determined by analyzing the circumference of the cap portion for each of the cap portions 205 of the plurality of mushroom 200 from a top perspective as discussed above.

The first category may also or alternatively analyze the shape and/or color of a mushroom 200 to determine whether the cap portion 205 of the mushroom 200 is bruised, diseased, or otherwise damaged. That is, the processing/analyzing module 2440 may be configured to determine the color of the cap portion 205 of the mushroom 200 or one or more portions of the mushroom 200, as well as the sizes(s) of such portion(s), to determine whether the cap portion 205 of the mushroom 200 is damaged. For example, one or more damaged portions of the cap portion 205 of the mushroom 200 will be assigned one color, such as a darker color (or multiple colors), and one or more undamaged portions of the cap portion 205 of the mushroom 200 will be assigned another color, such as a lighter color (or multiple colors different than those assigned to the damaged portion(s)). That is, a damaged portion of the cap portion 205 of the mushroom 200 will be identified as having a darker color, and the undamaged portion of the cap portion 205 of the mushroom 200 will be identified as having a lighter color.

Continuing to refer to FIG. 26, step 2608 may determine whether the mushroom 200 is acceptable based on the first category. For example, if an amount of pixels of the cap portion 205 of the mushroom 200 indicative of being undamaged (or an area of the mushroom 200 indicative of being undamaged) exceeds a predetermined threshold or if a ratio of a number of pixels of the cap portion 205 of the mushroom 200 indicative of being undamaged (or an area of the mushroom 200 indicative of being undamaged) to a number of pixels of the cap portion 205 of the mushroom 200 indicative of being damaged (or an area of the mushroom 200 indicative of being damaged) exceeds a predetermined threshold, the mushroom 200 will be deemed acceptable. Alternatively, if an amount of pixels of the cap portion 205 of the mushroom 200 indicative of being damaged (or an area of the mushroom 200 indicative of being damaged) exceeds a predetermined threshold or if a ratio of a number of pixels of the cap portion 205 of the mushroom 200 indicative of being damaged (or an area of the mushroom 200 indicative of being damaged) to a number of pixels of the cap portion 205 of the mushroom 200 indicative of being undamaged (or an area of the mushroom 200 indicative of being undamaged) exceeds a predetermined threshold, the mushroom 200 will be deemed unacceptable.

As shown in step 2610 of FIG. 26, if the mushroom 200 is unacceptable, it remains in the tray 100, 1600 and the mushroom is discarded from the tray (after the acceptable mushrooms are removed from the tray using the sorting device). As shown in step 2612, if a mushroom 200 is determined to be acceptable, then a corresponding suction cup 2128 (via activation of the vacuum device), will suction the acceptable mushroom 200 from the tray. While removing or after removing the mushrooms 200 from the tray 100, 1600, the mushrooms 200, if necessary, are oriented relative to the imaging device (e.g., camera) 2470 or relative to an additional imaging device or the orientation of the imaging device (e.g., camera) 2470 or additional imaging device is altered relative to the mushrooms. For example, the while the mushrooms 200 are being held by the respective suction cups 2128, the prime mover 2150 receives a signal from the workstation 2400 (or one of its modules) to rotate and orient the sorting device 2100, including the sub-assembly(s) 2104, pneumatic rod(s) 2114 and/or suction cup(s) 2128, at angle relative to the plane of the tray 100, 1600. The angle may be between 0 and 90 degrees or any increment therebetween, such as 5, 10, 15, 20, 25, 30, 35, 40, 45, 50, 55, 60, 65, 70, 75, 80, 85 or 90 degrees. Rotating the sorting device 2100 at such angle reduces the likelihood of any debris falling onto the imaging device (e.g., camera) 2470 or the additional imaging device. To minimize such likelihood, it may be desirable to have the imaging device (e.g., camera) 2470 disposed above or directly above the tray 100, 1600 and the additional imaging device also disposed above or directly above the tray 100, 1600 but oriented at the same angle the sorting device 2100 rotates. Again, the movement and orientation of the imaging device (e.g., camera) 2470 and/or sorting device 2100 (or sub-assembly 2104) relative to one another may be accomplished by the imaging module 2425, the sorting module 2450 or another module (such as an orientation module), not shown, which is logically coupled to and communicates with the prime movers 2485 to move and orient the imaging device (e.g., camera) 2470, the tray 100, 1600 and/or sorting device 2100 (or sub-assembly 2104) in or to a desirable position to image the mushrooms.

As discussed above, mushrooms will be imaged from a top perspective while the mushrooms remain in the funnel tray 100, 1600, and the mushrooms will subsequently be imaged from a bottom perspective while being removed or after being removed from the tray 100, 1600. When imaging the mushroom from a bottom perspective, the mushroom will be imaged while being held by the sorting device 2100, including the sub-assembly(s) 2104, pneumatic rod(s) 2114 and/or suction cup(s) 2128. Again, when imaging the mushroom from a bottom perspective, either the same camera used to image the mushroom from a top perspective or a different camera configured to image the mushroom from a bottom perspective or both cameras may be used. Imaging the mushrooms from a bottom perspective while being removed from the funnel tray or after being removed from the funnel tray and while being held by the sorting device 2100 improves the line of sight of the mushrooms because the funnel tray may obscure a portion of the bottom view of the mushrooms.

As such, step 2614 may comprise imaging a bottom view of a plurality of the mushrooms 200 while the mushrooms 200 while being removed from the funnel tray or after being removed from the funnel tray and while being held by the sorting device 2100, including the sub-assembly(s) 2104, pneumatic rod(s) 2114 and/or suction cup(s) 2128. Step 2616 may comprise co-registering each image of the bottom view of the mushroom 200 with the top view of the mushrooms 200. As such, the images of the bottom view and the top view of the mushroom 200 can be correlated. Step 2618 may comprise calculating or determining the size, shape, color, and/or other distinguishing feature(s) of the bottom portion of the plurality of mushrooms 200 based on the bottom view images of mushrooms 200. For example, the processing/analyzing module 2440 may determine whether the bottom portion of the plurality of mushrooms comprise gills or an excessive threshold number of gills based on a number of pixels of the bottom view image having dark grayscale values, as discussed above. Step 2618 may also comprise calculating or determining the size, shape, color, and/or other distinguishing feature(s) of the mushroom 200 based on the bottom view images 2430 of the mushrooms 200. Step 2618 may also comprise assigning a second category to each mushroom 200 based on or according to the size, shape, color, and/or other distinguishing feature(s) of the bottom view of the plurality of mushroom 200 (or the images thereof) as determined by the processing/analyzing module 2440. The overall size or categorization of the mushrooms may also be adjusted and/or determined by the weight of the mushrooms 200 in conjunction with the forgoing.

Optionally, as shown in step 2620, a third category may be assigned to each mushroom 200, wherein the third category is based on the first category and/or the second category or a combination of the size, shape, color, and/or other distinguishing feature(s) of the cap portions 205 of the plurality of mushroom 200 and the bottom parts of the plurality of mushroom 200 (or the images thereof) as determined by the processing/analyzing module 2440.

Continuing to refer to FIG. 26, step 2622 may comprise determining whether each of the plurality of mushrooms 200 is acceptable based on the category (e.g., first category, second category or third category) assigned to such mushroom. If a mushroom 200 is determined to be unacceptable, then a suction cup 2128 (via activation or deactivation of the vacuum device), will be deactivated for the corresponding unacceptable mushroom 200 and such mushroom 200 will be released into one or more similar containers designated for discarded or recycled mushrooms. If a mushroom 200 is determined to be acceptable, then a corresponding suction cup 2128 (via activation or deactivation of the vacuum device), will be deactivated for the corresponding acceptable mushroom 200 and such mushroom 200 will be released over a container assigned a particular designation such that acceptable mushrooms 200 having the same designation are placed in one or more similar designated containers. For example, upon determining that a mushroom 200 is acceptable based on the bottom-view image of the mushroom, the mushroom may be deposited in a container designated for extra-small, small, medium, large or extra-large mushrooms based on the top-view image of the mushroom, which upon being analyzed, also produced an acceptable determination. Additionally or alternatively, upon determining that the mushroom 200 is at least partially acceptable based on the top-view image of the mushroom and/or based on the bottom-view image of the mushroom, the mushroom may be deposited in a container designated for slicing.

Although the steps in both FIGS. 25 and 26 are shown in a particular order and some steps are depicted in one figure and not the other figure, it shall be understood that this disclosure contemplates using any step from FIG. 25 in FIG. 26, or vice versa, or the steps of FIGS. 25 and 26 can be combined in any fashion or order.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A container tray comprising:
a top side;
a bottom side; and
a plurality of funnel-shaped receptacles, wherein each of the plurality of funnel-shaped receptacles comprises a top opening on the top side, a bottom opening on the bottoms side, and a wall extending from the top opening to the bottom opening, wherein the top opening has a size and the bottom opening has a size, wherein the size of the top opening is greater than the size of the bottom opening and wherein the wall is extends radially inward as the wall extends vertically from the top opening to the bottom opening.

2. The container tray of claim 1, wherein the plurality of funnel-shaped receptacles are arranged in a plurality of rows and a plurality of columns.

3. The container tray of claim 1, wherein the plurality of funnel-shaped receptacles comprise a centrally located funnel-shaped receptacle relative to four funnel-shaped receptacles.

4. The container tray of claim 3, wherein the four funnel-shaped receptacles are spaced evenly around a circumference for the centrally located funnel-shaped receptacle.

5. The container tray of claim 4, wherein the four funnel-shaped receptacles are spaced 90 degrees around the circumference for the centrally located funnel-shaped receptacle.

6. The container tray of claim 5, wherein the centrally located funnel-shaped receptacle comprises a rim, and the four surrounding funnel-shaped receptacles share a portion of the rim of the centrally located funnel-shaped receptacle.

7. The container tray of claim 1, wherein the plurality of funnel-shaped receptacles comprise a centrally located funnel-shaped receptacle relative to five funnel-shaped receptacles.

8. The container tray of claim 7, wherein the five funnel-shaped receptacles are spaced evenly around a circumference for the centrally located funnel-shaped receptacle.

9. The container tray of claim 8, wherein the five funnel-shaped receptacles are spaced 72 degrees around the circumference for the centrally located funnel-shaped receptacle.

10. The container tray of claim 9, wherein the centrally located funnel-shaped receptacle comprises a rim, and the five surrounding funnel-shaped receptacles share a portion of the rim of the centrally located funnel-shaped receptacle.

11. The container tray of claim 1, wherein the plurality of funnel-shaped receptacles comprise a centrally located funnel-shaped receptacle relative to six funnel-shaped receptacles.

12. The container tray of claim 11, wherein the six funnel-shaped receptacles are spaced evenly around a circumference for the centrally located funnel-shaped receptacle.

13. The container tray of claim 12, wherein the six funnel-shaped receptacles are spaced 60 degrees around the circumference for the centrally located funnel-shaped receptacle.

14. The container tray of claim 13, wherein the centrally located funnel-shaped receptacle comprises a rim, and the six surrounding funnel-shaped receptacles share a portion of the rim of the centrally located funnel-shaped receptacle.

15. The container tray of claim 1 further comprising a plurality of gussets, wherein each of the plurality of gussets is coupled to two funnel-shaped receptacles.

16. The container tray of claim 15, wherein at least one of the plurality of gussets is triangularly shaped as the at least one of the plurality of gussets extends from the top side to the bottom side.

17. The container tray of claim 15, wherein at least two of the plurality of gussets cross.

18. The container tray of claim 17, wherein the at least one of the plurality of gussets are triangularly shaped as the at least two of the plurality of gussets extend from the top side to the bottom side.

19. The container tray of claim 1, further comprising a means for stacking the container tray to another container tray.

20. The container tray of claim 19, wherein the means for stacking the container tray to another container tray comprise a plurality of protrusions extending from the top side.

21. A device for individually transporting a plurality of mushrooms from a container tray, the device comprising:
a frame;
a plurality of movable suction cups coupled to and extending from the frame;
a pressure source fluidly coupled to the plurality of the movable suction cups;
a computing system comprising:
one or more processors; and
memory storing instructions that, when executed by the one or more processors, cause the one or more processors to:
receive a plurality of image signals corresponding to a plurality of images of a plurality of mushrooms within a tray;
co-register the plurality of image signals and a plurality of positions corresponding to the plurality of mushrooms within the tray;
determine a size, shape, color and/or other feature of each of the plurality of mushrooms based on the corresponding image for each of the plurality of mushrooms;
assign a category to each of the plurality of mushrooms based on the size, shape, color and/or other feature of each of the plurality of mushrooms;
determine whether each of the plurality of mushrooms is acceptable based on the category assigned to each of the plurality of mushrooms; and
engage the movable suction cups corresponding to each of the plurality of mushrooms determined to be acceptable.

22. The device of claim 21, wherein co-registering the plurality of image signals and the plurality of positions corresponding to the plurality of mushrooms comprises co-registering the plurality of movable suction cups with the plurality of positions corresponding to the plurality of mushrooms.

23. The device of claim 21, wherein receiving the plurality of image signals corresponding to the plurality of images of the plurality of mushrooms comprises receiving a first plurality of image signals corresponding to a plurality of images of a plurality of caps of the mushrooms.

24. The device of claim 23, wherein co-registering the plurality of image signals and the plurality of positions corresponding to the plurality of mushrooms comprises co-registering the plurality of images of the plurality of caps of the mushrooms and the plurality of positions corresponding to the plurality of mushrooms.

25. The device of claim 24, further comprising co-registering the plurality of movable suction cups with the plurality of positions corresponding to the plurality of caps of the mushrooms.

26. The device of claim 23, wherein assigning the category to each of the plurality of mushrooms is based on the size, shape, color and/or other feature of each of the plurality of mushroom caps.

27. The device of claim 23, wherein receiving the plurality of image signals corresponding to the plurality of images of the plurality of mushrooms comprises receiving a second plurality of image signals corresponding to a plurality of images of a plurality of stems of the mushrooms.

28. The device of claim 27, wherein co-registering the plurality of image signals and the plurality of positions corresponding to the plurality of mushrooms comprises co-registering the plurality of images of the plurality of caps of the mushrooms, the plurality of stems of the mushrooms and the plurality of positions corresponding to the plurality of mushrooms.

29. The device of claim 28, further comprising co-registering the plurality of movable suction cups with the plurality of positions corresponding to the plurality of caps of the mushrooms.

30. The device of claim 29, wherein assigning the category to each of the plurality of mushrooms is based on the size, shape, color and/or other feature of each of the plurality of mushroom caps and stems of the mushrooms.

31. The device of claim 21 further comprising engaging the movable suction cups corresponding to each of the plurality of mushrooms determined to be unacceptable.

32. The device of claim 31 further comprising removing each of the plurality of mushrooms determined to be unacceptable from the tray.

33. The device of claim 32 further comprising separating the plurality of mushrooms determined to be unacceptable from the plurality of mushrooms determined to be acceptable.

34. The device of claim 21 further comprising removing each of the plurality of mushrooms determined to be acceptable from the tray.

35. The device of claim 34 further comprising separating the plurality of mushrooms determined to be unacceptable from the plurality of mushrooms determined to be acceptable.

36. A device for individually transporting a plurality of mushrooms from a container tray, the device comprising:
a frame;
at least one prime mover coupled to the frame, wherein the at least one prime mover configured to move the frame;
a plurality of suction cups coupled to and extending from the frame;
a pressure source fluidly coupled to the plurality of the suction cups;
a computing system comprising:
one or more processors; and
memory storing instructions that, when executed by the one or more processors, cause the one or more processors to:
receive a plurality of image signals corresponding to a plurality of top-view images of a plurality of mushrooms within a tray;
determine a size, shape, color and/or other feature of each of the plurality of mushrooms based on the corresponding top-view image for each of the plurality of mushrooms;
assign a category to each of the plurality of mushrooms based on the size, shape, color and/or other feature of each of the plurality of mushrooms;
determine whether each of the plurality of mushrooms is acceptable based on the category assigned to each of the plurality of mushrooms;
engage the suction cups corresponding to each of the plurality of mushrooms determined to be acceptable, wherein the suction cups remove the plurality of mushrooms from the tray;
receive a plurality of image signals corresponding to a plurality of bottom-view images of a plurality of mushrooms while retained by the movable suction cups;
determine whether each of the plurality of mushrooms is acceptable based on the corresponding bottom-view image for each of the plurality of mushrooms; and
sort each of the plurality of mushrooms based on (i) the size, shape, color and/or other feature of each of the plurality of mushrooms and (ii) a determination from the bottom-view image that the each of the plurality of mushrooms is acceptable.

37. The device of claim 36, wherein each of the plurality of mushrooms determined to be unacceptable remains in the tray.

38. The device of claim 37, wherein the memory storing instructions that, when executed by the one or more processors, cause the one or more processors to move the tray containing the plurality of mushrooms determined to be unacceptable.

39. The device of claim 36, wherein the category assigned to each of the plurality of mushrooms is based on the size of each of a top portion of the plurality of mushrooms.

40. The device of claim 39, wherein the determination from the bottom-view image of whether each of the plurality of mushrooms is acceptable is based on a color of a bottom portion of each of the plurality of mushrooms.

41. The device of claim 36, wherein the category assigned to each of the plurality of mushrooms is based on the color of each of a top portion of the plurality of mushrooms.

42. The device of claim 41, wherein the determination from the bottom-view image of whether each of the plurality of mushrooms is acceptable is based on a color of a bottom portion of each of the plurality of mushrooms.

43. The device of claim 36, wherein the category assigned to each of the plurality of mushrooms is based on the size and the color of each of a top portion of the plurality of mushrooms.

44. The device of claim 43, wherein the determination from the bottom-view image of whether each of the plurality of mushrooms is acceptable is based on a color of a bottom portion of each of the plurality of mushrooms.

45. The device of claim 36, wherein the category assigned to each of the plurality of mushrooms is based on the size, the shape and the color of each of a top portion of the plurality of mushrooms.

46. The device of claim 45, wherein the determination from the bottom-view image of whether each of the plurality of mushrooms is acceptable is based on a color of a bottom portion of each of the plurality of mushrooms.

47. The device of claim 36, wherein the determination from the bottom-view image of whether each of the plurality of mushrooms is acceptable is based on a color of a bottom portion of each of the plurality of mushrooms.
